(19) United States
(12) Patent Application Publication
(10) Pub. No.: US 2022/0276696 A1
(43) Pub. Date: Sep. 1, 2022

(54) ASYNCHRONOUS MULTI-ENGINE VIRTUAL REALITY SYSTEM WITH REDUCED VESTIBULAR-OCULAR CONFLICT

(71) Applicant: BigBox VR, Inc., Seattle, WA (US)

(72) Inventors: Gabe Brown, Seattle, WA (US); Chia Chin Lee, Seattle, WA (US)

(21) Appl. No.: 17/186,703

(22) Filed: Feb. 26, 2021

(51) Int. Cl. G06F 3/01; G06T 11/00; G06T 1/20; G06F 3/0346

(52) U.S. Cl. CPC G06F 3/011; G06T 11/00; G06T 1/20; G06F 3/0346; G06T 2200/24

(57) ABSTRACT

Example embodiments are provided related to a multi-engine asynchronous virtual reality system within which vestibular-ocular conflicts are reduced or eliminated. In an example embodiment, an apparatus detects, via a first processor, one or more positional coordinates from one or more virtual reality devices. The apparatus further detects, via the first processor, one or more movement parameters associated with a virtual reality rendering. The apparatus, upon determining, via a second processor and based at least in part on simulation of the one or more positional coordinates and the movement parameters, that one or more movement parameter of the one or more movement parameters exceeds a first physical movement threshold, further adjusts, via the first processor, periphery occlusion associated with the virtual reality rendering.

### FIELD

The present application relates generally to virtual reality systems and, more particularly, to an asynchronous multi-engine virtual reality system with reduced vestibular-ocular conflict.

### BACKGROUND

Virtual reality systems provide computer-generated environments and experiences for users within which perceived objects, scenes, movements, and other interactions appear to be real (e.g., not computer-generated) to the users. Users interact with virtual reality systems through various electronic devices, including virtual reality headsets, head mounted displays, virtual reality devices, and/or multi-projector environments.

Applicant has identified that existing virtual reality experiences suffer from a multitude of challenges and drawbacks, several solutions to which are described herein with respect to various embodiments of the present disclosure.

### SUMMARY

Embodiments of the present disclosure relate to an asynchronous multi-engine virtual reality system where vestibular-ocular conflicts are reduced. Embodiments of the present disclosure enable various novel virtual reality experiences. Embodiments of the present disclosure enable significant performance savings, including a reduction of computing resources as compared to conventional systems. Moreover, embodiments of the present disclosure enable performance measurement and monitoring in order to ensure a given experience meets performance requirements in order to minimize the impact of vestibular-ocular conflict to the extent that is biologically possible.

Example embodiments are provided related to a multi-engine asynchronous virtual reality system within which vestibular-ocular conflicts are reduced or eliminated. In an example embodiment, an apparatus detects, via a first processor, one or more positional coordinates from one or more virtual reality devices. The apparatus further detects, via the first processor, one or more movement parameters associated with a virtual reality rendering. The apparatus, upon determining, via a second processor and based at least in part on simulation of the one or more positional coordinates and the one or more movement parameters, that the movement parameters exceed a first physical movement threshold, further adjusts, via the first processor, periphery occlusion associated with the virtual reality rendering.

Various other aspects are also described in the following detailed description and in the attached claims.

### BRIEF DESCRIPTION

Having thus described some embodiments in general terms, references will now be made to the accompanying drawings, which are not drawn to scale, and wherein:

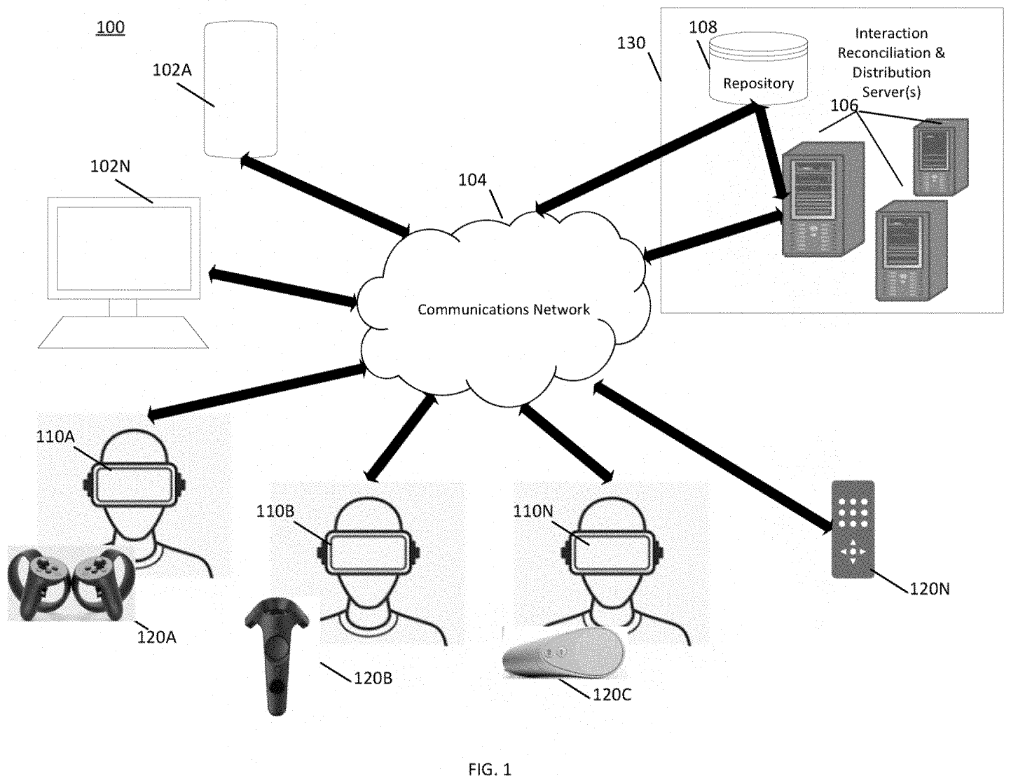

FIG. 1 illustrates an example system architecture within which embodiments of the present disclosure may operate.

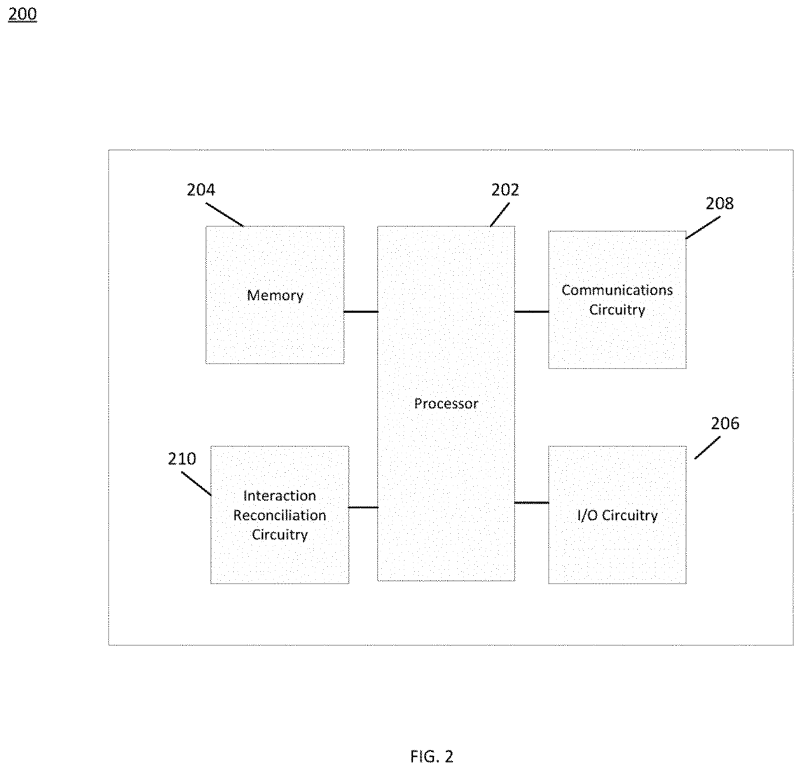

FIG. 2 illustrates an example apparatus for use with various embodiments of the present disclosure.

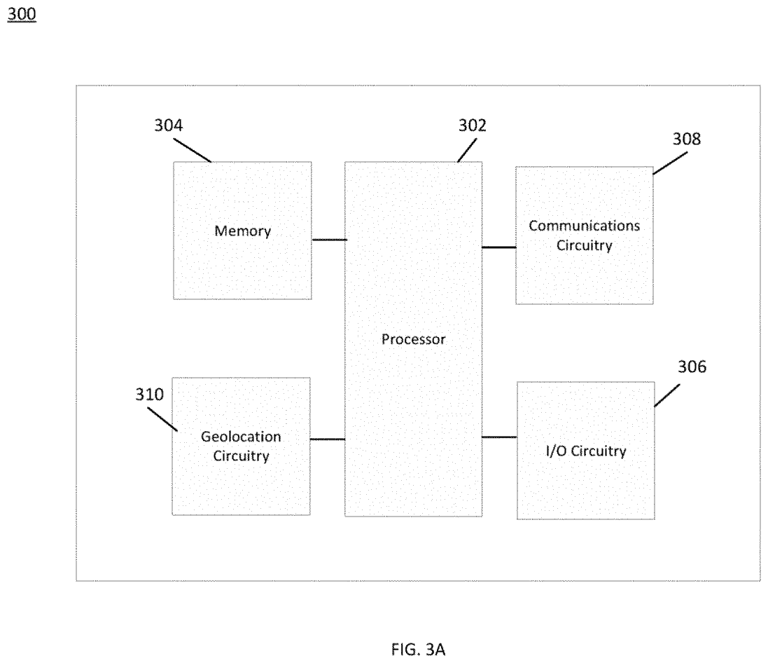

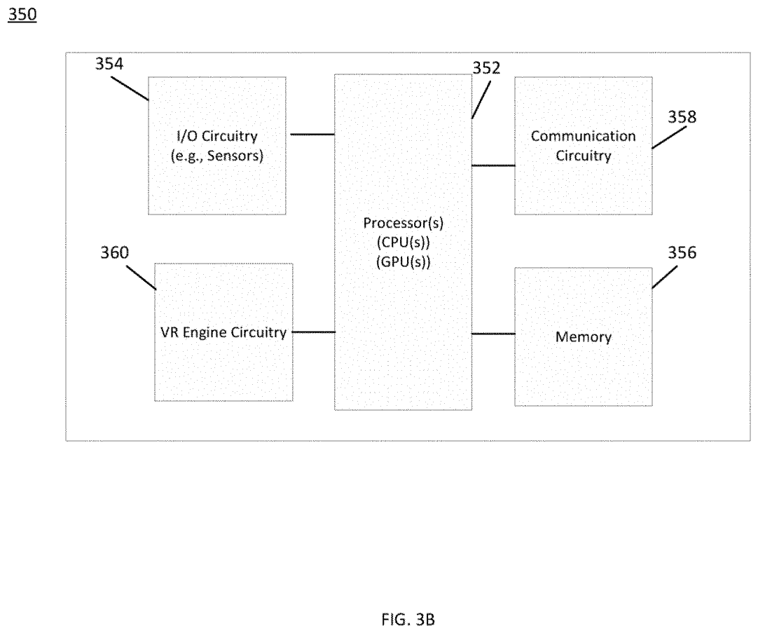

FIG. 3A illustrates an example apparatus for use with various embodiments of the present disclosure.

FIG. 3B illustrates an example apparatus for use with various embodiments of the present disclosure.

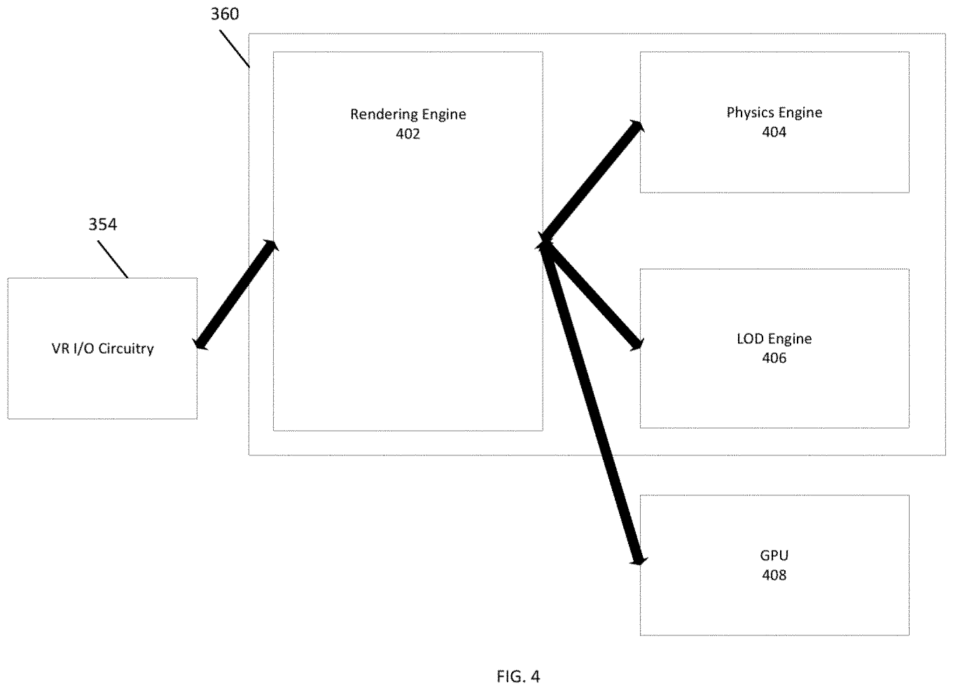

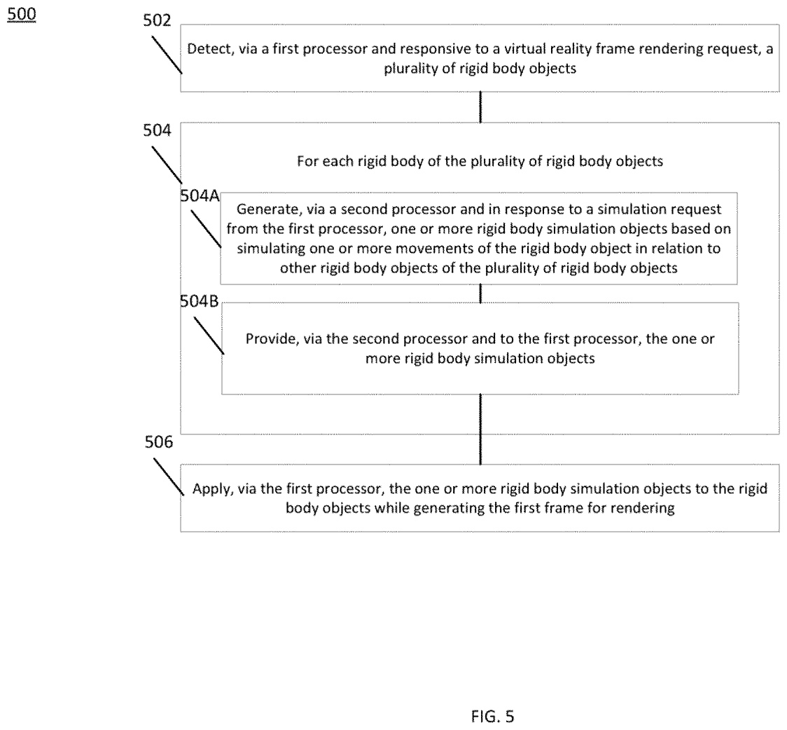

FIG. 4 functional block diagram of an example rendering engine for use with embodiments of the present disclosure.

FIG. 5 illustrates an example process flow diagram for use with embodiments of the present disclosure.

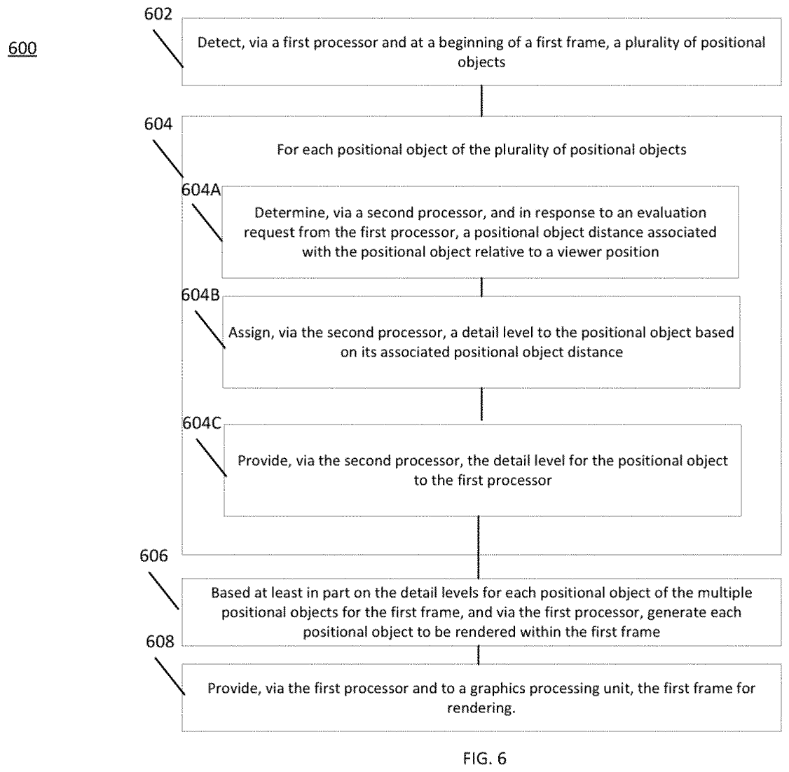

FIG. 6 illustrates an example process flow diagram for use with embodiments of the present disclosure.

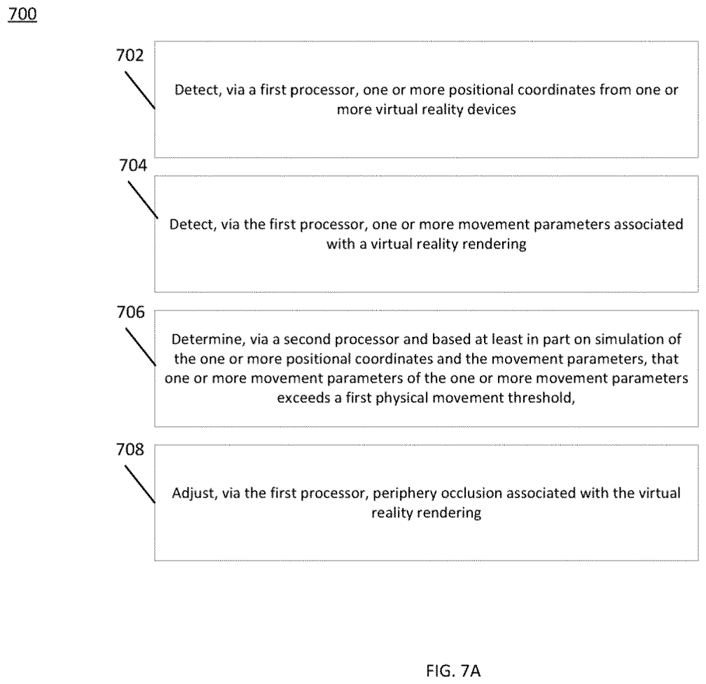

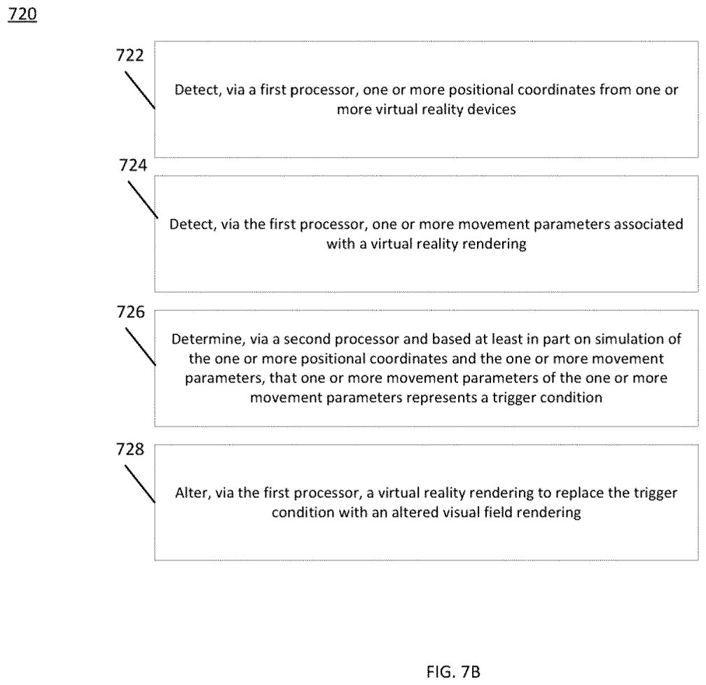

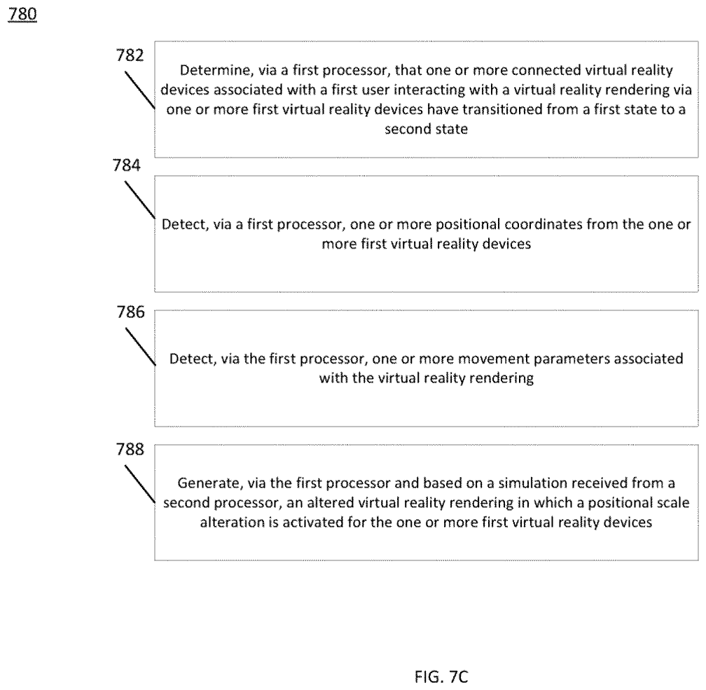

FIG. 7A illustrates an example process flow diagram for use with embodiments of the present disclosure.

FIG. 7B illustrates an example process flow diagram for use with embodiments of the present disclosure.

FIG. 7C illustrates an example process flow diagram for use with embodiments of the present disclosure.

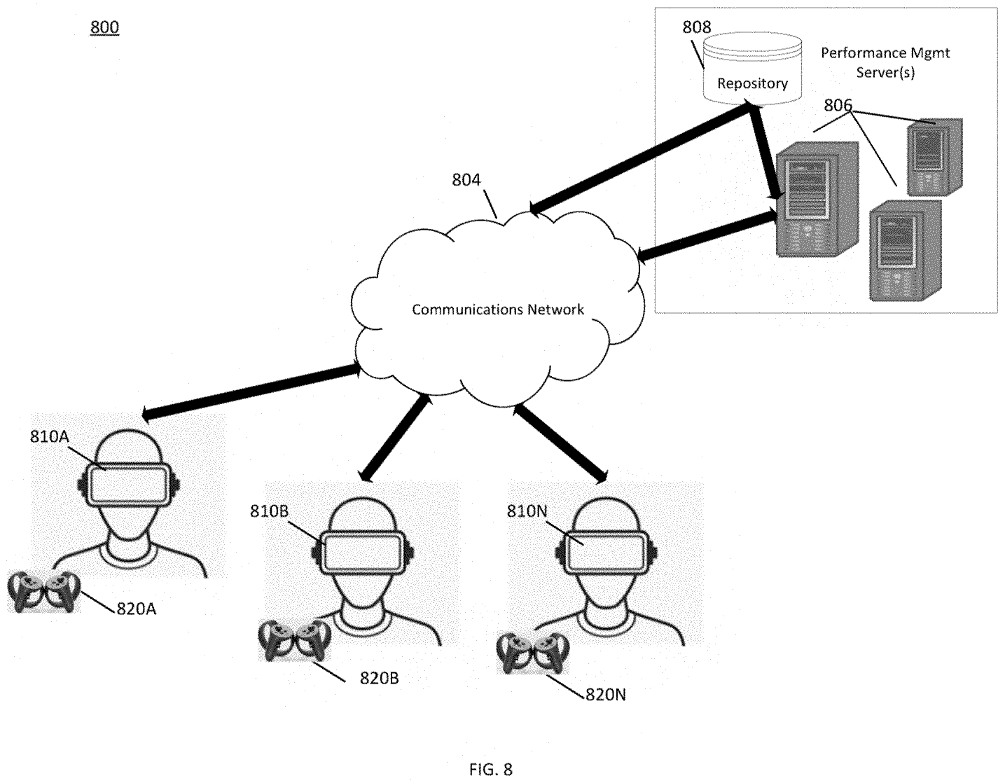

FIG. 8 illustrates an example performance measurement system for use with embodiments of the present disclosure.

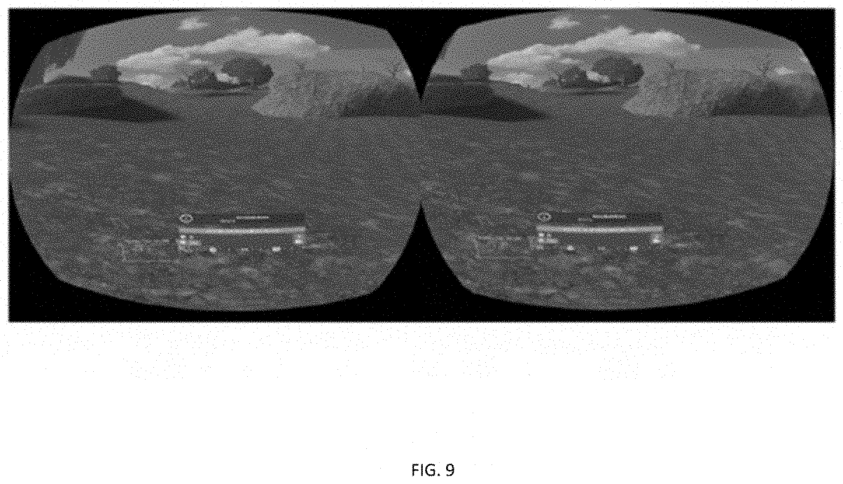

FIG. 9 illustrates an example virtual reality rendering for use with embodiments of the present disclosure.

### DETAILED DESCRIPTION

Various embodiments of the present disclosure will now be described more fully hereinafter with reference to the accompanying drawings, in which some, but not all embodiments of the present disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

Overview

Embodiments of the present disclosure relate to an asynchronous multi-engine virtual reality system where vestibular-ocular conflicts are reduced. A vestibular-ocular conflict is a disagreement between signals interpreted by a brain of a user of a virtual reality system, the signals being those received as a result of the user's vestibular experience or interpretation and those received as a result of the user's ocular experience or interpretation. That is, when ocular signals indicate to the user's brain that the user is in a particular motion state while vestibular signals indicate to the user's brain that the user is not in the particular motion state (e.g., or not moving at all), there is a conflict. Another non-limiting example of a conflict may be when ocular signals indicate (e.g., to the user's brain) a first particular motion state while vestibular signals indicate (e.g., to the user's brain) a second particular motion state, where the first and second motion states are different. Such conflict may lead to unfortunate and varying levels of side effects in various users, including but not limited to motion sickness. Vestibular-ocular conflict also arises when the quality of ocular signals does not meet a certain threshold. Specifically, ocular signals that result from renderings having low frame rates (e.g., measured in frames per second) may result in user discomfort and motion sickness.

Embodiments of the present disclosure eliminate or reduce vestibular-ocular conflicts by dynamically applying peripheral occlusion within a virtual environment specific to a given user's perceived movements in virtual space and/or the given user's individual susceptibility to motion sickness. It will be appreciated that rapid vertical movement within virtual reality is a condition known to induce motion sickness and embodiments herein enable such rapid vertical movement (e.g., climbing, falling, etc.) while maintaining user comfort within the environment.

Embodiments of the present disclosure further eliminate or reduce vestibular-ocular conflicts by intercepting certain rigid body movements by a user in virtual space before they are rendered and replacing them with a similarly perceived experience that will not result in the vestibular-ocular conflict that may have resulted from the originally intercepted rigid body movements in virtual space and associated renderings. Embodiments herein leverage discovered understandings of certain rigid body movements which may be commonly performed by a user interacting within virtual space that typically lead to vestibular-ocular conflict in the user.

Embodiments of the present disclosure enable an altered, or a second, virtual reality rendering based on a determination of a user transitioning within a virtual space to a different or specific state. For example, in a given virtual reality application session, a user may transition from a first state to a second state, where, in the second state, the virtual reality rendering may be altered. For example, virtual reality rendering in the second state may be altered by a positional scale, where the virtual reality objects and/or the virtual reality environment as a whole may be scaled to a smaller size (e.g., 1/10^{th} of original size). In embodiments, a user may experience the virtual environment in a first state where user input into the system (e.g., through a remote or an input controller) prompts certain rigid body movements by a user in virtual space to be rendered. The user may then transition to a second state (e.g., as a result of certain actions by the user and/or certain actions by another user) where certain rigid body movements by a user in virtual space may be intercepted before they are rendered or utilized to update a rendering. In certain embodiments, certain rigid body movements may be intercepted while other certain movements may continue to be rendered.

Embodiments of the present disclosure enable virtual reality environments having optimal frame rates (e.g., greater than 70 frames per second) while sparing computing resources from exhaustion and excessive delays through the employment of asynchronous simulations and computations separate from a main rendering engine. That is, a rendering engine according to embodiments herein may offload physics simulation processes to an asynchronous physics engine that may execute on a different processor, processor core, or processing thread from the rendering engine, thereby freeing up the main processor/core/thread for the rendering engine and reducing latency with respect to generating and rendering virtual reality frames. Further, the rendering engine according to embodiments herein may offload level of detail determinations to an asynchronous level of detail engine that may execute on a different processor, processor core, or processing thread from the rendering engine. It will be appreciated that the rendering engine, physics engine, and level of detail engines described herein are executed on a virtual reality device (e.g., client-side) and not necessarily on a server device supporting the virtual reality environment. Accordingly, the present embodiments which provide local processing and an optimal frame rate with a reduction in vestibular-ocular conflict present several significant improvements over existing virtual reality systems and environments.

### Definitions

As used herein, the terms “data,” “content,” “digital content,” “information,” and similar terms may be used interchangeably to refer to data capable of being transmitted, received, and/or stored in accordance with embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The terms “computer-readable storage medium” refers to a non-transitory, physical or tangible storage medium (e.g., volatile or non-volatile memory), which may be differentiated from a “computer-readable transmission medium,” which refers to an electromagnetic signal. Such a medium can take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums can be substituted for or used in addition to the computer-readable storage medium in alternative embodiments.

The terms “client device,” “computing device,” “network device,” “computer,” “user equipment,” and similar terms may be used interchangeably to refer to a computer comprising at least one processor and at least one memory. In some embodiments, the client device may further comprise one or more of: a display device for rendering one or more of a graphical user interface (GUI), a vibration motor for a haptic output, a speaker for an audible output, a mouse, a keyboard or touch screen, a global position system (GPS) transmitter and receiver, a radio transmitter and receiver, a microphone, a camera, a biometric scanner (e.g., a fingerprint scanner, an eye scanner, a facial scanner, etc.), or the like. Additionally, the term “client device” may refer to computer hardware and/or software that is configured to access a service made available by a server. The server is often, but not always, on another computer system, in which case the client accesses the service by way of a network. Embodiments of client devices may include, without limitation, smartphones, tablet computers, laptop computers, personal computers, desktop computers, enterprise computers, and the like. Further non-limiting examples include wearable wireless devices such as those integrated within watches or smartwatches, eyewear, helmets, hats, clothing, earpieces with wireless connectivity, jewelry and so on, universal serial bus (USB) sticks with wireless capabilities, modem data cards, machine type devices or any combinations of these or the like.

The term “virtual reality device” refers to a computing device that provides a virtual reality experience for a user interacting with the device. A virtual reality device may comprise a virtual reality headset, which may include a head mounted device having a display device (e.g., a stereoscopic display providing separate images for each eye; see, e.g., FIG. 9), stereo sound, and various sensors (e.g., gyroscopes, eye tracking sensors, accelerometers, magnetometers, and the like). A virtual reality device may, in addition to or alternatively, comprise handheld devices providing additional control and interaction with the virtual reality experience for the user. It will be appreciated that separate images for each eye, in a stereoscopic display and various embodiments herein, are rendered simultaneously. That is, a frame of a virtual reality rendering may include an image projected for the left eye and an image projected for the right eye where both images are rendered simultaneously.

The term “circuitry” may refer to: hardware-only circuit implementations (e.g., implementations in analog circuitry and/or digital circuitry); combinations of circuits and one or more computer program products that comprise software and/or firmware instructions stored on one or more computer readable memory devices that work together to cause an apparatus to perform one or more functions described herein; or integrated circuits, for example, a processor, a plurality of processors, a portion of a single processor, a multicore processor, that requires software or firmware for operation even if the software or firmware is not physically present. This definition of “circuitry” applies to all uses of this term herein, including in any claims. Additionally, the term “circuitry” may refer to purpose built circuits fixed to one or more circuit boards, for example, a baseband integrated circuit, a cellular network device or other connectivity device (e.g., Wi-Fi card, Bluetooth circuit, etc.), a sound card, a video card, a motherboard, and/or other computing device.

The terms “virtual reality,” “virtual environment,” “virtual space,” “VR,” and “virtual reality environment” refer to computer-generated environments and experiences for users within which perceived objects, scenes, movements, and other interactions appear to be real (e.g., not computer-generated) to the users. Users may interact with virtual reality systems through various electronic devices, including virtual reality headsets, virtual reality devices, and/or multi-projector and sensor environments. In embodiments, a virtual environment includes stereoscopic imagery used to simulate depth perception.

The term “virtual reality application session” refers to a particular execution of a given virtual reality application, usually having a starting timestamp and a completion timestamp and associated with one or more users interacting with the virtual reality application session via one or more virtual reality devices. As an example, a virtual reality application session may include a group of users competing with or against each other in a specific application from start to finish. The virtual reality application session is associated with an identifier as well as various metadata, including timestamps such as when the session started and completed, the user identifiers associated with the users interacting within the session, performance data, among other information.

The term “virtual reality application session identifier” refers to one or more items of data by which a virtual reality application session may be uniquely identified.

The term “virtual reality application session object” refers to one or more items of data associated with a virtual reality application session, such as objects for rendering via interfaces during the virtual reality application session.

The term “vestibular-ocular conflict” refers to a disagreement between signals interpreted by a brain of a user of a virtual reality system, the signals being those received as a result of the user's vestibular experience or interpretation and those received as a result of the user's ocular experience or interpretation. That is, when ocular signals indicate to the user's brain that the user is in a particular motion state while vestibular signals indicate to the user's brain that the user is not in the particular motion state (e.g., or not moving at all), there is a conflict. Such conflict may lead to unfortunate and varying levels of side effects in various users, including but not limited to motion sickness.

The term “comfort” refers to a condition or feature provided or enabled by various embodiments of the present disclosure whereby a user of the virtual reality system experiences little or no motion sickness due to the aforementioned vestibular-ocular conflicts.

The terms “frame” or “virtual reality frame” refer to a digital image, usually one of many still images that make up a perceived moving picture on an interface. A frame may be comprised of a plurality of pixels, arranged in relation to one another. Each pixel of a frame may be associated with a color space value (e.g., RGB).

The term “frame rate” refers to a frequency (e.g., rate) at which consecutive frames (e.g., images) appear on a display interface. While frame rate herein may be described with respect to frames per second (e.g., the number of images displayed every second), such references are not intended to be limiting. Embodiments herein enable achieving a high enough frame rate with respect to a virtual reality environment or application session (e.g., rendering of virtual reality renderings or frames) to avoid user disorientation, nausea, and other negative side effects that may result from too slow of a frame rate. For example, when a frame rate is too low, a user may experience the aforementioned vestibular-ocular conflicts. It is appreciated that a user's eye (e.g., ocular) and vestibular systems are biologically connected. The biological connection between the ocular and vestibular systems and associated reactions occur at high speeds (e.g., approximately every 7-8 milliseconds). As such, it may be preferable to achieve a high enough frame rate as to replicate the natural frequency at which the optical signals and vestibular signals are communicated to and processed by the brain; otherwise, vestibular-ocular conflict may arise. Accordingly, a frame rate of greater than 70 frames per second (e.g., Hz) may be preferred in certain embodiments (e.g., in some embodiments, 90 frames per second may be preferred). In various embodiments, a preferred range of rendering frame rate may be from 72 Hz to 90 Hz (e.g., 31.8 ms or 11.1 ms, respectively).

The term “frame identifier” refers to one or more items of data by which a frame of a virtual reality rendering may be uniquely identified.

In embodiments, each frame of a virtual reality rendering has a field of view. In embodiments, each frame of the virtual reality rendering has a field of view for each eye (e.g., where a display device of a virtual reality headset includes a stereoscopic display providing separate images for each eye). That is, a frame of a virtual reality rendering may have a first field of view intended for a first eye of a user and a second field of view intended for a second eye of the user.

The term “user identifier” refers to one or more items of data by which a user of a virtual reality system or application session may be uniquely identified.

The term “peripheral occlusion” refers to a programmatic alteration to a virtual reality frame or rendering whereby a certain portion of a periphery of the frame or rendering for a user is dimmed, reduced in brightness, rendered as a dark color with no pattern, or blocked. For example, through the use of peripheral occlusion, a user's attention (e.g., eyes) may be drawn to a center of the virtual reality frame or rendering by reducing or eliminating features from the periphery of the frame or rendering. Peripheral occlusion may also be referred to herein as applying a vignette, although such references are not intended to be limiting. Peripheral occlusion may also be referred to herein as narrowing a field of view for a given user, although such references are not intended to be limiting.

The term “dynamic peripheral occlusion” refers to varying levels and applications of peripheral occlusion within a virtual reality application session. For example, rather than merely occluding a periphery or not occluding a periphery, embodiments of the present disclosure may decide whether and an extent to which a periphery should be occluded based upon various detected conditions or thresholds. In certain examples, a first movement threshold (e.g., a certain simulated level of negative acceleration) may trigger the application of a first level peripheral occlusion for a first user, while a second movement threshold (e.g., a different level of negative acceleration) may trigger the application of a second level of peripheral occlusion for the first user. In other examples, aspects of peripheral occlusion (e.g., an area of occluded periphery, darkness of occlusion) may be directly proportional to a quantitative measure of movement (e.g., velocity, acceleration, direction). Accordingly, the peripheral occlusion is dynamic in that varying levels may be applied based at least upon detected or simulated movement parameters.

In embodiments, the dynamic peripheral occlusion is configurable per user. In certain examples, a first movement threshold may trigger the application of a first level of peripheral occlusion for a first user because the first user has programmatically indicated to the virtual reality system that the first user experiences significant motion sickness. In the same example, the first movement threshold may trigger the application of a second, lesser, level of peripheral occlusion for a second user because the second user has programmatically indicated to the virtual reality system that the system user experiences motion sickness to a lesser degree as compared to the first user. Accordingly, peripheral occlusion is configurable per user.

In embodiments, the dynamic peripheral occlusion may be altered over time for a given user according to learned motion sickness tolerances. That is, a given user's tolerance to motion sickness or movement in virtual environments may improve over time, thereby reducing the requisite or preferred levels of periphery occlusion to apply for the given user. Embodiments herein employ machine learning to determine a relationship between various movement parameters recorded in association with a given user and the given user's tolerance to vestibular-ocular conflicts and, based on the determined relationship, embodiments herein may automatically and programmatically adjust levels of peripheral occlusion for the user over time.

The terms “physical movement threshold” or “movement threshold” refer to a limit placed upon parameters associated with movement within a virtual reality environment in order to trigger peripheral occlusion within a rendering for the virtual reality environment. In certain embodiments, movement thresholds may be associated with parameters such as negative vertical acceleration (e.g., whereby a rigid body is “falling” within a simulation or virtual reality environment). Various levels of negative vertical acceleration (e.g., varying speeds associated with the “falling”) may be associated with different movement thresholds, thereby triggering differing levels of peripheral occlusion or other rendering alterations as described herein. It will be appreciated that, while example embodiments described herein apply peripheral occlusion according to thresholds based on negative vertical acceleration, application of rendering alterations based on other movement related parameters and thresholds are within the scope of the present disclosure.

The term “interaction reconciliation” refers to server-side processing of interaction data received from one or more virtual reality devices, whereby the interaction data and resulting collisions or outcomes are reconciled in order to confirm that a virtual reality application session is free from undesired manipulation (e.g., cheating). For example, in a given virtual reality application session, a rigid body associated with a first user (e.g., interacting with the virtual reality application session using one or more first virtual reality devices such as a virtual reality headset and one or more virtual reality handheld devices) may appear to have caused a rigid body associated with a second user (e.g., interacting with the virtual reality application session using one or more second virtual reality devices such as a virtual reality headset and one or more virtual reality handheld devices) to have a collision with a particular virtual reality application session object or virtual reality object (e.g., to have been hit by a bullet) which may ultimately lead to a particular outcome (e.g., the second user is eliminated from the session). Rather than blindly trusting the current interaction and outcome data provided by the one or more first virtual reality devices, an interaction reconciliation server (e.g., or one or more interaction reconciliation servers or computing devices; e.g., or one interaction reconciliation server per virtual reality headset device) may retrieve and process interaction data received prior to the current data in order to recreate the scenario and confirm the outcome. For example, the one or more interaction reconciliation servers may retrieve the interaction data associated with the first user's rigid body interacting or colliding with a particular virtual reality object (e.g., the first user pulling a trigger) and simulate, according to a physics engine, the timing and pathway associated with another virtual reality object (e.g., a bullet) caused to “move” or “travel” as a result of the collision to confirm that the another virtual reality object (e.g., the bullet) actually would have traveled in a manner such that it would have collided with the second user's rigid body as reported by the one or more first virtual reality devices.

The terms “virtual reality engine,” “VR engine,” or “rendering engine” refer to a module or process providing programmatic generation of three-dimensional virtual reality environments, where the three-dimensional virtual reality environments comprise a virtual space filled with virtual reality objects and are presented to a user by way of a virtual reality display device in the form of a plurality of frames (e.g., through a user interface). The virtual reality engine (e.g., also referred to herein without limitation as a rendering engine) may be associated with multiple engines responsible for various sub-processes for use in generating and displaying virtual reality frames. For example, a virtual reality engine may determine, upon receiving or detecting a request for generating a virtual reality frame, that simulation of one or more physical systems in given dimensions is necessary for determining how to render one or more virtual objects. In such examples, the virtual reality engine may schedule such a job for execution by an asynchronous physics engine, which then may execute the simulation using a separate processor, processor core, or processing thread from that upon which the virtual reality or rendering engine is executing. The virtual reality engine may further determine, upon receiving or detecting a request for generating a virtual reality for rendering, that one or more virtual reality objects require a level of detail determination (e.g., to determine an optimal level of detail with which to render the one or more virtual reality objects). In such examples, the virtual reality engine may schedule such a job for execution by an asynchronous level of detail engine, which then may execute the level of detail analysis using an even further separate processor, processor core, or processing thread from that upon which the virtual reality engine is executing and from that upon which the asynchronous physics engine may be executing. The virtual reality engine may further be configured to, upon completion of generating a frame for rendering, provide the frame at the determined level of detail to a graphics processing unit (GPU) for rendering.

The term “physics engine” refers to an asynchronous module or process providing simulation of one or more physical systems (e.g., collisions, rigid body movements, rotation calculations, friction, gravity, and the like) in given dimensions (e.g., two-dimensional, three-dimensional). In embodiments, the simulation models real-world physics and provides simulation data to a virtual reality engine or a rendering engine so that a representation (e.g., or altered representation) of the simulated real-world physics may be rendered within a virtual reality environment. It will be appreciated that, in embodiments herein, a main rendering or VR engine may alter a rendering of the simulated physics based on various decision criteria. An asynchronous physics engine may execute using a different processor, processor core, or processing thread from a main rendering or VR engine, responsive to a simulation request from the main rendering or VR engine, thereby reducing load and latency associated with a processor, processor core, or processing thread associated with the main rendering or VR engine. It will be appreciated that the physics engine simulates the real-world physics associated with movement parameters and location or positional coordinates in real-time and is used to model the motion of a virtual reality object (e.g., a rigid body representation of a user's physical body) in the virtual reality environment.

The term “level of detail engine” refers to an asynchronous module or process providing programmatic determination of an optimal level of detail with which a given virtual reality object should be rendered within a virtual reality frame or rendering. For example, when the given virtual reality object is determined to be a certain distance from the user's perceived location within a virtual reality environment or application session, the level of detail engine may determine that the virtual reality object may be rendered with a lower level of detail (e.g., a reduction in image quality). Such reduction in the level of detail reduces rendering workload, thereby reducing required resources as well as improving frame rate, without noticeably impacting a user's experience or perception of the virtual reality object. An asynchronous level of detail engine may execute using a different processor, processor core, or processing thread from a main rendering or VR engine, responsive to a level of detail determination request from the main rendering or VR engine, thereby reducing load and latency associated with a processor, processor core, or processing thread associated with the main rendering or VR engine. The asynchronous level of detail engine may further execute using a different processor, processor core, or processing thread from an asynchronous physics engine as described herein.

The term “positional object” may refer to a virtual reality object for which a level of detail is determined. That is, a positional object is a virtual reality object and is associated with a level of detail generated based upon a distance away from a user's perceived location within the virtual environment associated with the positional object. For example, a positional object may be a house in the distance, a tree, another virtual reality rigid body, and the like.

The term “positional scale alteration” refers to a computing alteration or adjustment made to a perceived scale within a virtual reality environment associated with a given user device (e.g., a given virtual reality device or set of devices associated with a particular user identifier). The positional scale alteration may be triggered or initiated (e.g., by a specific event in a virtual reality application session or by a specific user input). For example, when one or more users of a set of users associated with a given user identifier (e.g., a set of users competing as a squad within a multi-player virtual reality application session) is identified as having transitioned to an elimination state (e.g., has been eliminated as a participant of the particular virtual reality application session), a visual field rendered for the given user device may transition such that the positional scale is significantly expanded for the given user (e.g., a user may be able to perceive flight or perceive that they are a multiple of their original height, for example, 10×, so that the perceived vantage of the user within the virtual reality application session is accordingly expanded).

The terms “rigid body” and “rigid body object” refer to computer-generated representations of a user's physical body where the user is interacting with a virtual reality environment by way of one or more virtual reality devices. It will be appreciated that “rigid body” and “rigid body object” can also include objects that are not representations of a user's physical body, such as a bullet, a grenade, or another generic mass. Rigid body objects may be simulated in an asynchronous physics engine to simulate motion of said objects as a result of user input and/or other simulated forces. Rigid body objects may be simulated in an asynchronous physics engine with the assumption that any two given points on a rigid body remain at a constant distance from one another regardless of external forces or moments exerted on the rigid body. A rigid body object may be a solid body in which deformation is zero or so small it can be neglected. That is, the object is “rigid.” In embodiments, rigid bodies and rigid body objects may be simulated as continuous distributions of mass.

The term “collision” refers to a computer-generated interaction for display via a virtual reality rendering whereby a collision occurs between a virtual object (e.g., a virtual tree, a virtual building, a virtual item for carrying) in a virtual environment and another virtual object object (e.g., a rigid body representation of a user's physical body and/or other rigid body objects or moving objects such as bullets, grenades, and the like).

The term “movement state” refers to a status of movement of a rigid body within a virtual reality environment, where the movement state is determined based upon movement parameters and positional coordinates and, in embodiments, determined by a physics engine. Examples of movement states include but are not limited to standing, walking, running, climbing, pre-falling, falling, flying, zooming, or flinging. In embodiments, a movement state may enable enables a user's rigid body to move and remain steady at any given position horizontally or vertically within a virtual space with the effect of gravity being ignored.

The term “movement parameter” refers to one or more movement related measurements associated with a rigid body representation of a user's physical body within a virtual reality system or environment. That is, a rigid body representation may be associated with a given acceleration, velocity, force, direction of travel, or other measurements related to movement. For example, if a rigid body associated with a user is “falling” within a virtual reality environment (e.g., if the rigid body has fallen from a tree or building, etc.), the rigid body may be associated with a negative vertical acceleration, as well as a measure of that negative vertical acceleration. As previously mentioned, movement parameters may impact certain renderings of the virtual reality environment, such determining a dynamic level of peripheral occlusion.

The term “positional coordinate” refers to one or more items of data associated with physical positioning of a physical body within three dimensions associated with a user of a virtual reality system. That is, based upon sensors associated with one or more virtual reality devices with which the user is interacting, positional coordinates associated with the user's physical body may be determined (e.g., where are the user's hands, movement of the user's head/hands/body, and the like).

The term “trigger condition” refers to a programmatically detected combination of positional coordinates (e.g., determined based upon positions of one or more virtual reality devices with which a user is interacting), where the combination of positional coordinates represents or is associated with a rigid body movement or set of rigid body movements that may lead to motion sickness in the user. For example, if the rigid body representation of a user is “flying” within a virtual reality environment and the user's physical body causes the one or more virtual reality devices to move in a manner such that one or more parts of the rigid body representation would, according to a physics simulation, tilt and rotate to the right and back to the left horizontally as well as vertically, the trigger condition may exist because such tilting may cause a vestibular-ocular conflict leading to motion sickness in the user. A trigger condition may be determined by a combination of both positional coordinates and movement parameters. Another trigger condition may be determined by a combination of only movement parameters.

The term “in-flight experience alteration” refers to a programmatic replacement of objects within a virtual reality rendering or frame based upon detection of a trigger condition. For example, upon detection of a trigger condition, a virtual reality rendering engine or a physics engine may, instead of rendering virtual reality objects according to the trigger condition (e.g., whereby objects may appear according to the user's rigid body tilting to the right and then tilting back to the left in a vertical and horizontal manner and so on), render virtual reality objects according to an altered visual field rendering (e.g., whereby objects will appear according to a “head” of the user's rigid body merely turning to the left and turning to the right, remaining a horizontal movement). In embodiments, such in-flight experience alteration reduces vestibular-ocular conflicts and therefore reduces motion sickness in the virtual reality environment.

The term “collider object” refers to a virtual reality object that may or may not move, with which a rigid body object (defined above) may collide. In embodiments, a collider object represents an object's shape in 3 dimensions.

### Example System Architecture For Use With Embodiments Herein

Methods, apparatuses, and computer program products of the present disclosure may be embodied by any of a variety of devices. For example, the method, apparatus, and computer program product of an example embodiment may be embodied by a networked device, such as a server (e.g., or servers) or other network entity, configured to communicate with one or more devices, such as one or more virtual reality devices and/or computing devices. Additionally or alternatively, the computing devices may include fixed computing devices, such as a personal computer or a computer workstation. Still further, example embodiments may be embodied by any of a variety of mobile devices, such as a portable digital assistant (PDA), mobile telephone, smartphone, laptop computer, tablet computer, wearables, virtual reality headsets, virtual reality handheld devices, multi-projector and sensor environments, other virtual reality hardware, the like or any combination of the aforementioned devices.

FIG. 1 illustrates an example system architecture 100 within which embodiments of the present disclosure may operate. The architecture 100 includes a virtual reality processing system 130 configured to interact with one or more client devices 102A-102N, as well as one or more virtual reality devices 110A-110N (e.g., virtual reality headset devices 110A, 110B, . . . 110N) and 120A-120N (e.g., virtual reality handheld devices 120A. 120B, 120C, . . . 120N). The virtual reality processing system 130 may be configured to receive interaction data from the one or more virtual reality devices 110A-110N, 120A-120N, as well as the one or more client devices 102A-102N. The virtual reality processing system 130 may further be configured to reconcile virtual reality movement data based on the received interaction data and distribute (e.g., transmit) reconciled or confirmed interaction data to the one or more virtual reality devices 110A-110N, 120A-120N, and/or the one or more client devices 102A-102N.

The virtual reality processing system 130 may communicate with the client devices 102A-102N and the one or more virtual reality devices 110A-110N, 120A-120N using a communications network 104. The network 104 may include any wired or wireless communication network including, for example, a wired or wireless local area network (LAN), personal area network (PAN), metropolitan area network (MAN), wide area network (WAN), the like, or combinations thereof, as well as any hardware, software and/or firmware required to implement the network 104 (e.g., network routers, etc.). For example, the network 104 may include a cellular telephone, an 802.11, 802.16, 802.20, and/or WiMAX network. Further, the network 104 may include a public network, such as the Internet, a private network, such as an intranet, or combinations thereof, and may utilize a variety of networking protocols now available or later developed including, but not limited to Transmission Control Protocol/Internet Protocol (TCP/IP) based networking protocols. In some embodiments, the protocol is a custom protocol of JavaScript Object Notation (JSON) objects sent via a Web Socket channel. In some embodiments, the protocol is JSON over RPC, JSON over REST/HTTP, the like, or combinations thereof.

The virtual reality processing system 130 may include one or more interaction reconciliation and distribution servers 106 and one or more repositories 108 for performing the aforementioned functionalities. The repositories 108 may include one or more storage units, such as multiple distributed storage units that are connected through a computer network. Each storage unit in the repositories 108 may store at least one of one or more data assets and/or one or more data about the computed properties of one or more data assets. Moreover, each storage unit in the repositories 108 may include one or more non-volatile storage or memory media including but not limited to hard disks, ROM, PROM, EPROM, EEPROM, flash memory, MMCs, SD memory cards, memory sticks, CBRAM, PRAM, FeRAM, NVRAM, MRAM, RRAM, SONOS, FJG RAM, Millipede memory, racetrack memory, the like, or combinations thereof.

### Example Apparatuses For Use With Embodiments Herein

The interaction reconciliation and distribution server(s) 106 may be embodied by one or more computing systems, such as apparatus 200 shown in FIG. 2. The apparatus 200 may include processor 202, memory 204, input/output circuitry 206, communications circuitry 208, and interaction reconciliation circuitry 210. The apparatus 200 may be configured to execute the operations described herein. Although these components 202-210 are described with respect to functional limitations, it should be understood that the particular implementations necessarily include the use of particular hardware. It should also be understood that certain of these components 202-210 may include similar or common hardware. For example, two sets of circuitries may both leverage use of the same processor, network interface, storage medium, or the like to perform their associated functions, such that duplicate hardware is not required for each set of circuitries.

In some embodiments, the processor 202 (and/or co-processor or any other processing circuitry assisting or otherwise associated with the processor) may be in communication with the memory 204 via a bus for passing information among components of the apparatus. The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, instructions, or the like for enabling the apparatus to carry out various functions in accordance with example embodiments of the present disclosure.

The processor 202 may be embodied in a number of different ways and may, for example, include one or more processing devices configured to perform independently. In some preferred and non-limiting embodiments, the processor 202 may include one or more processors configured in tandem via a bus to enable independent and/or asynchronous execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 202 may be configured to execute instructions stored in the memory 204 or otherwise accessible to the processor 202. In some preferred and non-limiting embodiments, the processor 202 may be configured to execute hard-coded functionalities. As such, whether configured by hardware or software methods, or by a combination thereof, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure the processor 202 to perform the algorithms and/or operations described herein when the instructions are executed.

In some embodiments, the apparatus 200 may include input/output circuitry 206 that may, in turn, be in communication with processor 202 to provide output to the user and, in some embodiments, to receive an indication of a user input. The input/output circuitry 206 may comprise a user interface and may include a display, and may comprise a web user interface, a mobile application, a computing device, a kiosk, or the like. In some embodiments, the input/output circuitry 206 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like). It will be appreciated that the input/output circuitry 206 may also include web camera or other camera input or other input/output capabilities associated with virtual reality devices.

The communications circuitry 208 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally or alternatively, the communications circuitry 208 may include the circuitry for interacting with the antenna/antennae to cause transmission of signals via the antenna/antennae or to handle receipt of signals received via the antenna/antennae. The communications circuitry 208 may further be configured to communicate virtual reality application session data objects and associated updates to a set of virtual reality or other computing devices associated with a given virtual reality application session as is described herein.

The interaction reconciliation circuitry 210 may be any means such as a device or circuitry embodied in either hardware or a combination of hardware and software that is configured to receive electronic signals from one or more virtual reality devices and/or computing devices associated with virtual reality application sessions. In some embodiments, the interaction reconciliation circuitry 210 may be configured to, based on the received electronic signals, confirm virtual reality application session objects (e.g., session, collision, or movement outcomes or results) as well as location coordinates within a virtual reality environment of various rigid bodies or other moving objects within the virtual reality environment.

It is also noted that all or some of the information discussed herein can be based on data that is received, generated and/or maintained by one or more components of apparatus 200. In some embodiments, one or more external systems (such as a remote cloud computing and/or data storage system) may also be leveraged to provide at least some of the functionality discussed herein.

Referring now to FIG. 3A, client devices 102A-N may be embodied by one or more computing systems, such as apparatus 300 shown in FIG. 3A. The apparatus 300 may include processor 302, memory 304, input/output circuitry 306, communications circuitry 308, and geolocation circuitry 310. Although these components 302-310 are described with respect to functional limitations, it should be understood that the particular implementations necessarily include the use of particular hardware. It should also be understood that certain of these components 302-310 may include similar or common hardware. For example, two sets of circuitries may both leverage use of the same processor, network interface, storage medium, or the like to perform their associated functions, such that duplicate hardware is not required for each set of circuitries.

In some embodiments, the processor 302 (and/or co-processor or any other processing circuitry assisting or otherwise associated with the processor) may be in communication with the memory 304 via a bus for passing information among components of the apparatus. The memory 304 is non-transitory and may include, for example, one or more volatile and/or non-volatile memories. In other words, for example, the memory 304 may be an electronic storage device (e.g., a computer-readable storage medium). The memory 304 may include one or more databases. Furthermore, the memory 304 may be configured to store information, data, content, applications, instructions, services, or the like for enabling the apparatus 300 to carry out various functions in accordance with example embodiments of the present disclosure.

The processor 302 may be embodied in a number of different ways and may, for example, include one or more processing devices configured to perform independently. In some preferred and non-limiting embodiments, the processor 302 may include one or more processors configured in tandem via a bus to enable independent and/or asynchronous execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 302 may be configured to execute instructions stored in the memory 304 or otherwise accessible to the processor 302. In some preferred and non-limiting embodiments, the processor 302 may be configured to execute hard-coded functionalities. As such, whether configured by hardware or software methods, or by a combination thereof, the processor 302 may represent an entity (e.g., physically embodied in circuitry, etc.) capable of performing operations according to an embodiment of the present disclosure while configured accordingly. Alternatively, as another example, when the processor 302 is embodied as an executor of software instructions (e.g., computer program instructions, etc.), the instructions may specifically configure the processor 302 to perform the algorithms and/or operations described herein when the instructions are executed.

In some embodiments, the apparatus 300 may include input/output circuitry 306 that may, in turn, be in communication with processor 302 to provide output to the user and, in some embodiments, to receive an indication of a user input. The input/output circuitry 306 may comprise a user interface and may include a display, and may comprise a web user interface, a mobile application, a query-initiating computing device, a kiosk, or the like. In some embodiments, the input/output circuitry 306 may also include a keyboard (e.g., also referred to herein as keypad), a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 304, and/or the like). It will be appreciated that the input/output circuitry 306 may also include web camera or other camera input or other input/output capabilities associated with virtual reality devices.

The communications circuitry 308 may be any means such as a device or circuitry embodied in either hardware or a combination of hardware and software that is configured to receive and/or transmit data from/to a network and/or any other device, circuitry, or module in communication with the apparatus 300. In this regard, the communications circuitry 308 may include, for example, a network interface for enabling communications with a wired or wireless communication network. For example, the communications circuitry 308 may include one or more network interface cards, antennae, buses, switches, routers, modems, and supporting hardware and/or software, or any other device suitable for enabling communications via a network. Additionally or alternatively, the communications circuitry 308 may include the circuitry for interacting with the antenna/antennae to cause transmission of signals via the antenna/antennae or to handle receipt of signals received via the antenna/antennae.

The geolocation circuitry 310 may be any means such as a device or circuitry embodied in either hardware or a combination of hardware and software that is configured to report a current geolocation of the apparatus 300. In some embodiments, the geolocation circuitry 310 may be configured to communicate with a satellite-based radio-navigation system such as the global position satellite (GPS), similar global navigation satellite systems (GNSS), or combinations thereof, via one or more transmitters, receivers, the like, or combinations thereof. In some embodiments, the geolocation circuitry 310 may be configured to infer an indoor geolocation and/or a sub-structure geolocation of the apparatus 300 using signal acquisition and tracking and navigation data decoding, where the signal acquisition and tracking and the navigation data decoding is performed using GPS signals and/or GPS-like signals (e.g., cellular signals, etc.). Other examples of geolocation determination include Wi-Fi triangulation and ultra-wideband radio technology. The geolocation circuitry 310 may be capable of determining the geolocation of the apparatus 300 to a certain resolution (e.g., centimeters, meters, kilometers).

It is also noted that all or some of the information discussed herein can be based on data that is received, generated and/or maintained by one or more components of apparatus 300. In some embodiments, one or more external systems (such as a remote cloud computing and/or data storage system) may also be leveraged to provide at least some of the functionality discussed herein.

Referring now to FIG. 3B, virtual reality devices 110A-N may be embodied by one or more computing systems, such as apparatus 350 shown in FIG. 3B. The apparatus 350 may include processor(s) 352 (e.g., a plurality of processors), memory 354, input/output circuitry 356 (e.g., including a plurality of sensors), communications circuitry 358, and virtual reality (VR) engine circuitry 360. Although these components 352-360 are described with respect to functional limitations, it should be understood that the particular implementations necessarily include the use of particular hardware. It should also be understood that certain of these components 352-360 may include similar or common hardware. For example, two sets of circuitries may both leverage use of the same processor, network interface, storage medium, or the like to perform their associated functions, such that duplicate hardware is not required for each set of circuitries.

In some embodiments, the processor 352 (and/or co-processor or any other processing circuitry assisting or otherwise associated with the processor) may be in communication with the memory 354 via a bus for passing information among components of the apparatus. The memory 354 is non-transitory and may include, for example, one or more volatile and/or non-volatile memories. In other words, for example, the memory 354 may be an electronic storage device (e.g., a computer-readable storage medium). The memory 354 may include one or more databases. Furthermore, the memory 354 may be configured to store information, data, content, applications, instructions, services, or the like for enabling the apparatus 350 to carry out various functions in accordance with example embodiments of the present disclosure.

The processor(s) 352 may be embodied in a number of different ways and may, for example, include one or more processing devices configured to perform independently. In some preferred and non-limiting embodiments, the processor(s) 352 may include one or more processors configured in tandem via a bus to enable independent and/or asynchronous execution of instructions, pipelining, and/or multithreading. The use of the term “processing circuitry” may be understood to include a single core processor, a multi-core processor, multiple processors internal to the apparatus, and/or remote or “cloud” processors. The processor(s) 352 may further include other types of processors such as a GPU.

In some preferred and non-limiting embodiments, the processor 352 may be configured to execute instructions stored in the memory 354 or otherwise accessible to the processor 352. In some preferred and non-limiting embodiments, the processor 352 may be configured to execute hard-coded functionalities. As such, whether configured by hardware or software methods, or by a combination thereof, the processor 352 may represent an entity (e.g., physically embodied in circuitry, etc.) capable of performing operations according to an embodiment of the present disclosure while configured accordingly. Alternatively, as another example, when the processor 352 is embodied as an executor of software instructions (e.g., computer program instructions, etc.), the instructions may specifically configure the processor 302 to perform the algorithms and/or operations described herein when the instructions are executed.

In some embodiments, the apparatus 350 may include input/output circuitry 356 (e.g., including a plurality of sensors) that may, in turn, be in communication with processor 352 to provide output to the user and, in some embodiments, to receive an indication of a user input or movement. The input/output circuitry 356 may comprise a user interface and may include an electronic display (e.g., including a virtual interface for rendering a virtual reality environment or interactions, and the like), and may comprise a web user interface, a mobile application, a query-initiating computing device, a kiosk, or the like. In some embodiments, the input/output circuitry 356 may also include a hand controller, cameras for motion tracking, keyboard (e.g., also referred to herein as keypad), a mouse, a joystick, a touch screen, touch areas, soft keys, a microphone, a speaker, or other input/output mechanisms. In some embodiments, the input/output circuitry may further interact with one or more additional virtual reality handheld devices (e.g., 120A, 120B, 120C, . . . 120N) to receive further indications of user movements. The processor and/or user interface circuitry comprising the processor may be configured to control one or more functions of one or more user interface elements through computer program instructions (e.g., software and/or firmware) stored on a memory accessible to the processor (e.g., memory 354, and/or the like). It will be appreciated that the input/output circuitry 356 may also include web camera or other camera input or other input/output capabilities associated with virtual reality devices.

The communications circuitry 358 may be any means such as a device or circuitry embodied in either hardware or a combination of hardware and software that is configured to receive and/or transmit data from/to a network and/or any other device, circuitry, or module in communication with the apparatus 350. In this regard, the communications circuitry 358 may include, for example, a network interface for enabling communications with a wired or wireless communication network. For example, the communications circuitry 358 may include one or more network interface cards, antennae, buses, switches, routers, modems, and supporting hardware and/or software, or any other device suitable for enabling communications via a network. Additionally or alternatively, the communications circuitry 358 may include the circuitry for interacting with the antenna/antennae to cause transmission of signals via the antenna/antennae or to handle receipt of signals received via the antenna/antennae.

The VR engine circuitry 360 may be any means such as a device or circuitry embodied in either hardware or a combination of hardware and software that is configured to process movements associated with a user of the apparatus 350 as well as generate frames for rendering via a display device of the apparatus 350. In some embodiments, the VR engine circuitry 360 may be configured to utilize one or more of processor(s) 352 to accomplish necessary processing for generating frames for rendering, including scheduling asynchronous jobs assigned to various additional sub-engines of the VR engine circuitry 360 (e.g., a physics engine or LOD engine as discussed herein). In certain embodiments, the VR engine circuitry 360 may be configured to communicate (e.g., using communications circuitry 358) with and utilize one or more of processor(s) 352 of apparatus 350 to complete various processing tasks such as rendering and scheduling asynchronous jobs.

It is also noted that all or some of the information discussed herein can be based on data that is received, generated and/or maintained by one or more components of apparatus 350. In some embodiments, one or more external systems (such as a remote cloud computing and/or data storage system) may also be leveraged to provide at least some of the functionality discussed herein.

### Example Operations Of Embodiments of The Present Disclosure

FIG. 4 illustrates a functional block diagram of an example rendering circuitry for use with embodiments of the present disclosure. In embodiments, a virtual reality rendering engine 402 (e.g., as part of virtual reality rendering circuitry 360) provides, to a GPU 408 of a virtual reality hardware device, programmatic generation of three-dimensional virtual reality environments, where the three-dimensional virtual reality environments comprise a virtual space filled with virtual reality objects and are presented to a user by way of a virtual reality display device (not shown in FIG. 4) in the form of a plurality of frames (e.g., through a user interface). In embodiments, GPU 408 may be located within apparatus 350 and/or be one of processor(s) 352. A virtual reality or rendering engine 402 may schedule a job to execute using a physics engine 404 after determining, upon receiving or detecting a request for generating a virtual reality frame (e.g., via VR I/O circuitry 354), that simulation of one or more physical systems in given dimensions is necessary for determining how to render one or more virtual objects. The asynchronous physics engine 404 may execute the simulation using a separate processor, processor core, or processing thread from that upon which the virtual reality or rendering engine is executing. The asynchronous physics engine 404 may provide data and results of simulations back to the rendering engine 402 upon completion of said simulations or upon request by rendering engine 402. The virtual reality or rendering engine 402 may further schedule a job to execute using a level of detail (LOD) engine 406 after determining, upon receiving or detecting a request for generating a virtual reality for rendering (e.g., via VR I/O circuitry 354), that one or more virtual reality objects require a level of detail determination (e.g., to determine an optimal level of detail with which to render the one or more virtual reality objects). The asynchronous level of detail engine 406 may execute the level of detail analysis using an even further separate processor, processor core, or processing thread from that upon which the virtual reality or rendering engine 402 is executing and from that upon which the asynchronous physics engine 404 may be executing. The asynchronous level of detail engine 406 may provide data and results of the level of detail analysis back to the rendering engine 402 upon completion of said analysis or upon request by rendering engine 402. The virtual reality or rendering engine 402 may further be configured to, upon completion of generating a frame for rendering, provide the frame to a graphics processing unit (GPU) 408 for rendering via a display device of the virtual reality device (not shown in FIG. 4).

FIG. 5 illustrates a process flow 500 associated with example asynchronous physics engine for use with embodiments of the present disclosure. In embodiments, a multi-processor apparatus (e.g., apparatus 200, apparatus 350) includes multiple processors and is configured to detect 502, via a first processor and responsive to a virtual reality frame rendering request associated with a first frame, multiple rigid body objects.

In embodiments, the multi-processor apparatus is further configured to, for each rigid body object of the multiple rigid body objects 504, generate 504A, via a second processor and in response to a simulation request from the first processor, one or more rigid body simulation objects based on simulating one or more movements of the rigid body object in relation to other rigid body objects (e.g., other rigid body objects and/or collider objects) of the plurality of rigid body objects. In embodiments, the multi-processor apparatus is configured to simulate one or more movements of the rigid body object in relation to a combination of other rigid body objects and collider objects (e.g., objects that may result in a collision with the rigid body object). The multi-processor apparatus further configured to, for each rigid body, provide 504B, via the second processor and to the first processor, the one or more rigid body simulation objects.

In embodiments, the multi-processor apparatus is further configured to apply, 506, via the first processor, the one or more rigid body simulation objects to the rigid body objects while generating the first frame for rendering.

In embodiments, the virtual reality frame rendering request is received from one or more virtual reality devices. In embodiments, a particular rigid body is associated with one or more virtual reality devices and a user interacting therewith. In embodiments, one or more positional coordinates obtained from the one or more virtual reality devices result in a rigid body representation of a physical body of the user. In embodiments, the one or more virtual reality devices comprise one or more of a virtual reality headset device or virtual reality handheld devices.

In embodiments, movement parameters and/or positional coordinates comprising one or more of acceleration, velocity, or direction of travel associated with a rigid body representation of a physical body of a user interacting with the one or more virtual reality devices are accounted for in the simulation.

In embodiments, the multi-processor apparatus is further configured to provide, via the first processor and to a graphics processing unit, the first frame for rendering.

In embodiments, each of the first processor and the second processor comprise one or more of a processor, a processor core, or a processing thread.

In embodiments, the multi-processor apparatus is further configured to provide, to the graphics processing unit, a sequence of frames for rendering at a frame rate of at least 70 frames per second.

In embodiments, a simulation is based in part on gravity and collisions. In embodiments, a simulation request includes a request to perform a simulation and return results of the simulation in real time. In embodiments, a simulation request comprises a raycast or query request.

In embodiments, the multi-processor apparatus is further configured to run physics queries such as raycast requests, spherecast requests, checksphere requests, or capsulecast requests. Such physics queries enable the multi-processor apparatus to determine what virtual objects exist along a given vector, or a sphere traveling along a given vector.

FIG. 6 illustrates a process flow 600 associated with example asynchronous level of detail engine for use with embodiments of the present disclosure. In embodiments, a multi-processor apparatus includes multiple processors and is configured to detect 602, via a first processor and at a beginning of a first frame, multiple positional objects.

In embodiments, the multi-processor apparatus is further configured to, for each positional object of the plurality of positional objects 604, determine 604A, via a second processor and in response to an evaluation request from the first processor, a positional object distance associated with the positional object relative to a viewer position. In embodiments, a positional object distance may be determined relative to another position that is not the viewer position. For example, a viewer may be viewing the virtual reality environment from another point-of-view location; as such, the positional object distance would be determined relative to the alternative point-of-view location as opposed to a position of the viewer's rigid body. As another non-limiting example, a viewer may be viewing the virtual reality environment at a high magnification. In such a case, the positional object distance may be determined orthogonally from an artificial line extending from the viewer's position and the viewing target under magnification; resulting in objects at the center of the high magnification having a first positional object distance and objects further from the center of the high magnification having a different positional object distance. It will be appreciated that determining a positional object distance in this example may result in a more accurate representation of viewing a real-life environment under high magnification (e.g., through binoculars, telescopes, and/or the like).

In embodiments, the multi-processor apparatus is further configured to, for each positional object of the plurality of positional objects 604, assign 604B, via the second processor, a detail level to the positional object based on its associated positional object distance. In embodiments, a detail level may be a “zero” level where the positional object is not rendered at all. Those of skill in the art will understand that a positional object may be assigned a “zero” detail level when the positional object has a high positional object distance (determined in 604A) and has a small size. In embodiments, assigning 604B may be further based on the size of the positional object.

In embodiments, the multi-processor apparatus is further configured to, for each positional object of the plurality of positional objects 604, provide 604C, via the second processor, the detail level for the positional object to the first processor.

In embodiments, the multi-processor apparatus is further configured to, based at least in part on the detail levels for each positional object of the plurality of positional objects for the first frame, and via the first processor, generate 606 each positional object to be rendered at the provided level of detail within the first frame. In embodiments, a positional object with a “zero” detail level assigned to it may not be rendered at all.

In embodiments, the multi-processor apparatus is further configured to provide 608, via the first processor and to a graphics processing unit, the first frame for rendering via the graphics processing unit.

In embodiments, a positional object is one of a dynamic object or a static object. In embodiments, the multi-processor apparatus is further configured to, for each frame, update a detail level for a plurality of dynamic objects.

In embodiments, assigning the detail level to the positional object includes retrieving a previous associated positional object distance associated with the positional object, and upon determining that a current positional object distance is equivalent or within a distance threshold of the previous associated positional object distance, assigning a previous detail level to the positional object instead of calculating a new detail level for the positional object.

In embodiments, determining the positional object distance associated with the positional object relative to the viewer position comprises performing a line cast analysis.

In embodiments, each of the first processor and the second processor comprise one or more of a processor, a processor core, or a processing thread.

In embodiments, the apparatus provides, to the graphics processing unit, a sequence of frames for rendering at a frame rate of at least 70 frames per second.

FIG. 7A illustrates an example process flow diagram 700 for use with embodiments of the present disclosure. In embodiments, an apparatus (e.g., apparatus 200, apparatus 350) may be configured to apply dynamic periphery occlusion in a virtual reality system. In such embodiments, the apparatus includes at least one processor and at least one memory storing instructions that, with the at least one processor, configure the apparatus to detect 702, via a first processor, one or more positional coordinates from one or more virtual reality devices.

In embodiments, the apparatus is further configured to detect 704, via the first processor, one or more movement parameters associated with a virtual reality rendering.

In embodiments, the apparatus is further configured to, upon determining 706, via a second processor and based at least in part on simulation of the one or more positional coordinates and the movement parameters, that the movement parameters exceed a first physical movement threshold, adjust 708, via the first processor, periphery occlusion associated with the virtual reality rendering.

In embodiments, the first physical movement threshold is selected from a plurality of physical movement thresholds. The first physical movement threshold may be selected based at least in part on a movement state. In embodiments, the movement state is determined via the second processor and based at least in part on the simulation of the one or more positional coordinates and the movement parameters. In embodiments, the movement state is falling.

In embodiments, each physical movement threshold of the plurality of physical movement thresholds is adjustable for a given user via the one or more virtual reality devices.

In embodiments, each physical movement threshold of the plurality of physical movement thresholds dynamically updated over time based on movement parameters associated with a given user.

In embodiments, adjusting periphery occlusion associated with the virtual reality rendering comprises altering an area of pixels located along a periphery each eye's frame of the virtual reality rendering. In embodiments, altering the area of pixels comprises one or more of blurring each pixel of the area of pixels or applying a black color to each pixel of the area of pixels. In embodiments, adjusting periphery occlusion further comprises adjusting a size of the area of pixels based in part on the physical movement threshold.

In embodiments, the one or more virtual reality devices comprise one or more of a virtual reality headset device or virtual reality handheld devices. In embodiments, the one or more positional coordinates are associated with a physical body of a user interacting with the one or more virtual reality devices.

In embodiments, the movement parameters and/or positional coordinates comprise one or more of acceleration, velocity, or direction of travel and are associated with a rigid body representation of a physical body of a user interacting with the one or more virtual reality devices.

In embodiments, the apparatus is further configured to generate and provide, via the first processor and to a graphics processing unit, a frame for rendering including the periphery occlusion. In embodiments, the apparatus provides, to the graphics processing unit, a sequence of frames for rendering at a frame rate of at least 70 frames per second.

In embodiments, each of the first processor and the second processor comprise one or more of a processor, a processor core, or a processing thread.

FIG. 7B illustrates an example process flow diagram 720 for use with embodiments of the present disclosure. In embodiments, an apparatus may be configured to in-flight visual field alteration in a virtual reality system. In such embodiments, the apparatus includes at least one processor and at least one memory storing instructions that, with the at least one processor, configure the apparatus to detect 722, via a first processor, one or more positional coordinates from one or more virtual reality devices.

In embodiments, the apparatus is further configured to detect 724, via the first processor, one or more movement parameters associated with a virtual reality rendering.

In embodiments, the apparatus is further configured to, upon determining 726, via a second processor and based at least in part on simulation of the one or more positional coordinates and the movement parameters, that the movement parameters represent a trigger condition, alter 728, via the first processor, a virtual reality rendering to replace the trigger condition with an altered visual field rendering.

In embodiments, the trigger condition is a programmatically detected combination of positional coordinates representing a rigid body movement or set of rigid body movements that may lead to motion sickness in the user.

In embodiments, the one or more positional coordinates result in a rigid body representation of a user interacting with the one or more virtual reality devices horizontally and vertically alternating between tilting to the right and to the left.

In embodiments, the altered visual field rendering results in a head or visual field of the rigid body representation turning left and right in a horizontal manner.

In embodiments, the one or more virtual reality devices comprise one or more of a virtual reality headset device or virtual reality handheld devices. In embodiments, the one or more positional coordinates are associated with a physical body of a user interacting with the one or more virtual reality devices.

In embodiments, the movement parameters and/or positional coordinates comprise one or more of acceleration, velocity, or direction of travel and are associated with a rigid body representation of a physical body of a user interacting with the one or more virtual reality devices.

In embodiments, the apparatus is further configured to generate and provide, via the first processor and to a graphics processing unit, a frame for rendering including the altered visual field rendering. In embodiments, the apparatus provides, to the graphics processing unit, a sequence of frames for rendering at a frame rate of at least 70 frames per second.

In embodiments, each of the first processor and the second processor comprise one or more of a processor, a processor core, or a processing thread.

FIG. 7C illustrates an example process flow 780 diagram for use with embodiments of the present disclosure. In embodiments, an apparatus may activate positional scale alteration achieved by simulating an increase or decrease in the interocular distance in a virtual reality system, where the apparatus includes at least one processor and at least one memory storing instructions that, with the at least one processor, configure the apparatus to activate the positional scale alteration.

In embodiments, the apparatus is configured to, upon determining 782, via a first processor, that one or more connected virtual reality devices associated with a first user in a first state interacting with a virtual reality rendering via one or more first virtual reality devices have transitioned to a second state, detect 784, via a first processor, one or more positional coordinates from the one or more first virtual reality devices. For example, the first user may be competing against other users in a virtual reality application session in a first competitive state, and upon certain events occurring in the virtual reality application session, the first user may then transition to a second elimination state (such transition determined in 782). As another non-limiting example, the first user may be in a first idle state, and upon a specific user input/command or certain events within the virtual reality application session, the first user may transition to a second spectator state. The apparatus is further configured to detect 786, via the first processor, one or more movement parameters associated with the virtual reality rendering. The apparatus is further configured to generate 788, via the first processor and based on a simulation from the second processor, an altered virtual reality rendering in which a positional scale alteration is activated for the one or more first virtual reality devices by simulating an increase or decrease of the user's inter-eye distance. In embodiments, an increased inter-eye distance simulates a 10× height increase for the user within the virtual reality rendering.

In embodiments, the positional scale alteration results in an increased field of view for the user. In embodiments, the increased field of view comprises a 10× height enhancement for the user within the virtual reality rendering. In embodiments, the positional scale alteration may comprise rendering the virtual reality environment at fractional dimensions (e.g., 1/10^{th} of original size) and configuring the asynchronous physics engine to simulate objects at the same fractional dimension/size.

FIG. 8 illustrates an example performance measurement system 800 for use with embodiments of the present disclosure. In embodiments, a system 800 for monitoring or measuring performance of a virtual reality application and/or a virtual reality system includes a plurality of virtual reality devices 810A-810N (e.g., virtual reality headset devices 810A, 810B, . . . 810N) and 820A-820N (e.g., virtual reality handheld devices 820A, 820B, . . . 820N). The system 800 further includes one or more benchmark or performance management server devices 806 and a repository 808 (e.g., both in communication with the plurality of virtual reality devices). The devices may all be in communication via a network 804 (e.g., similar to communications network 104 described herein). It will be appreciated that virtual reality devices 810A-810N may be embodied similarly to virtual reality devices 110A-110N herein. It will further be appreciated that virtual reality devices 820A-820N may be embodied similarly to virtual reality devices 120A-120N herein.

In embodiments, the one or more benchmark or performance management server devices 806 are configured to record (e.g., either locally or in conjunction with repository 808) performance metrics associated with each virtual reality device of the plurality of virtual reality devices while all of the plurality of virtual reality headset devices simultaneously interact with a particular virtual reality application session.

In embodiments, the system 800 may further include a central server device (not shown in FIG. 8) in communication with the one or more benchmark server devices, where the central server device is configured to cause rendering of a virtual reality performance interface comprising one or more performance interface elements associated with the recorded performance metrics and the particular virtual reality application session.

In embodiments, performance metrics may include frame rate measurements such as average CPU frame time or GPU frame time, average frames per second, system and graphics, amount of data send and received over the network, network latency, component temperatures, among others. In addition to measuring these parameters on the device, the collected measurements or statistics are collected over multiple runs over multiple headsets to form a statistical picture on how a given device performs under normal variations that occur due to manufacturing differences and causes of random delays. This statistical picture may then be used to compare different versions of virtual reality environments and associated engines as described herein to determine if they are faster/slower, use more/less memory, generate more/less heat with the ability to detect changes as small as 0.3% change, and the like.

Various aspects of the present subject matter are set forth below, in review of, and/or in supplementation to, the embodiments described thus far, with the emphasis here being on the interrelation and interchangeability of the following embodiments. In other words, an emphasis is on the fact that each feature of the embodiments can be combined with each and every other feature unless explicitly stated otherwise or logically implausible.

In some embodiments, an apparatus for dynamic periphery occlusion in a virtual reality system includes at least one processor and at least one memory storing instructions that, with the at least one processor, configure the apparatus to detect, via a first processor, one or more positional coordinates from one or more virtual reality devices. In some of these embodiments, the apparatus is configured to detect, via the first processor, one or more movement parameters associated with a virtual reality rendering. In some of these embodiments, the apparatus is configured to, upon determining, via a second processor and based at least in part on simulation of the one or more positional coordinates and the one or more movement parameters, that one or more movement parameters of the one or more movement parameters exceeds a first physical movement threshold, adjust, via the first processor, periphery occlusion associated with the virtual reality rendering.

In some of these embodiments, the first physical movement threshold is selected from a plurality of physical movement thresholds. In some of these embodiments, the first physical movement threshold is selected based at least in part on a virtual movement state. In some of these embodiments, the virtual movement state is determined via the second processor and based at least in part on the simulation of the one or more positional coordinates and the one or more movement parameters. In some of these embodiments, the virtual movement state comprises a negative acceleration parameter exceeding a negative acceleration threshold. In some of these embodiments, each physical movement threshold of the plurality of physical movement thresholds is adjustable for a given user via the one or more virtual reality devices. In some of these embodiments, each physical movement threshold of the plurality of physical movement thresholds is dynamically updated over time based on historical movement parameters associated with a given user. In some of these embodiments, adjusting periphery occlusion associated with the virtual reality rendering comprises altering an area of pixels located along a periphery of each eye-specific frame of a frame of the virtual reality rendering.

In some of these embodiments, altering the area of pixels comprises one or more of blurring each pixel of the area of pixels or applying a uniform color to each pixel of the area of pixels. In some of these embodiments, adjusting periphery occlusion further comprises adjusting a size of the area of pixels based in part on the first physical movement threshold.

In some of these embodiments, the one or more virtual reality devices comprise one or more of a virtual reality headset device or virtual reality handheld devices.

In some of these embodiments, the one or more positional coordinates are associated with a physical body of a user interacting with the one or more virtual reality devices.

In some of these embodiments, the one or more movement parameters comprise one or more of acceleration, velocity, or direction of travel and are associated with a rigid body representation of a physical body of a user interacting with the one or more virtual reality devices.

In some of these embodiments, the apparatus is configured to generate and provide, via the first processor and to a graphics processing unit, a frame for rendering including the periphery occlusion.

In some of these embodiments, each of the first processor and the second processor comprise one or more of a processor, a processor core, or a processing thread.

In some of these embodiments, the apparatus is configured to provide, to the graphics processing unit, a sequence of frames for rendering at a frame rate of at least 70 frames per second.

In some embodiments, a computer program product comprising at least one non-transitory computer readable storage medium stores instructions that, when executed by at least one processor, configure an apparatus to detect, via a first processor, one or more positional coordinates from one or more virtual reality devices. In some of these embodiments, the apparatus is configured to detect, via the first processor, one or more movement parameters associated with a virtual reality rendering. In some of these embodiments, the apparatus is configured to, upon determining, via a second processor and based at least in part on simulation of the one or more positional coordinates and the one or more movement parameters, that one or more movement parameters of the one or more movement parameters exceeds a first physical movement threshold, adjust, via the first processor, periphery occlusion associated with the virtual reality rendering.

In some of these embodiments, the first physical movement threshold is selected from a plurality of physical movement thresholds. In some of these embodiments, the first physical movement threshold is selected based at least in part on a virtual movement state. In some of these embodiments, the virtual movement state is determined via the second processor and based at least in part on the simulation of the one or more positional coordinates and the one or more movement parameters. In some of these embodiments, the virtual movement state comprises a negative acceleration parameter exceeding a negative acceleration threshold. In some of these embodiments, each physical movement threshold of the plurality of physical movement thresholds is adjustable for a given user via the one or more virtual reality devices. In some of these embodiments, each physical movement threshold of the plurality of physical movement thresholds is dynamically updated over time based on historical movement parameters associated with a given user. In some of these embodiments, adjusting periphery occlusion associated with the virtual reality rendering comprises altering an area of pixels located along a periphery of each eye-specific frame of a frame of the virtual reality rendering.

In some of these embodiments, altering the area of pixels comprises one or more of blurring each pixel of the area of pixels or applying a uniform color to each pixel of the area of pixels. In some of these embodiments, adjusting periphery occlusion further comprises adjusting a size of the area of pixels based in part on the first physical movement threshold.

In some of these embodiments, the one or more virtual reality devices comprise one or more of a virtual reality headset device or virtual reality handheld devices.

In some of these embodiments, the one or more positional coordinates are associated with a physical body of a user interacting with the one or more virtual reality devices.

In some of these embodiments, the one or more movement parameters comprise one or more of acceleration, velocity, or direction of travel and are associated with a rigid body representation of a physical body of a user interacting with the one or more virtual reality devices.

In some of these embodiments, the apparatus is configured to generate and provide, via the first processor and to a graphics processing unit, a frame for rendering including the periphery occlusion.

In some of these embodiments, each of the first processor and the second processor comprise one or more of a processor, a processor core, or a processing thread.

In some of these embodiments, the apparatus is configured to provide, to the graphics processing unit, a sequence of frames for rendering at a frame rate of at least 70 frames per second.

In some embodiments, a computer implemented method comprises detecting, via a first processor, one or more positional coordinates from one or more virtual reality devices. In some of these embodiments, the method further comprises detecting, via the first processor, one or more movement parameters associated with a virtual reality rendering. In some of these embodiments, the method further comprises, upon determining, via a second processor and based at least in part on simulation of the one or more positional coordinates and the one or more movement parameters, that one or more movement parameters of the one or more movement parameters exceeds a first physical movement threshold, adjusting, via the first processor, periphery occlusion associated with the virtual reality rendering.

In some of these embodiments, the apparatus is configured to detect, via the first processor, one or more movement parameters associated with a virtual reality rendering. In some of these embodiments, the apparatus is configured to, upon determining, via a second processor and based at least in part on simulation of the one or more positional coordinates and the one or more movement parameters, that one or more movement parameters of the one or more movement parameters exceeds a first physical movement threshold, adjust, via the first processor, periphery occlusion associated with the virtual reality rendering.

In some of these embodiments, the first physical movement threshold is selected from a plurality of physical movement thresholds. In some of these embodiments, the first physical movement threshold is selected based at least in part on a virtual movement state. In some of these embodiments, the virtual movement state is determined via the second processor and based at least in part on the simulation of the one or more positional coordinates and the one or more movement parameters. In some of these embodiments, the virtual movement state comprises a negative acceleration parameter exceeding a negative acceleration threshold. In some of these embodiments, each physical movement threshold of the plurality of physical movement thresholds is adjustable for a given user via the one or more virtual reality devices. In some of these embodiments, each physical movement threshold of the plurality of physical movement thresholds is dynamically updated over time based on historical movement parameters associated with a given user. In some of these embodiments, adjusting periphery occlusion associated with the virtual reality rendering comprises altering an area of pixels located along a periphery of each eye-specific frame of a frame of the virtual reality rendering.

In some of these embodiments, altering the area of pixels comprises one or more of blurring each pixel of the area of pixels or applying a uniform color to each pixel of the area of pixels. In some of these embodiments, adjusting periphery occlusion further comprises adjusting a size of the area of pixels based in part on the first physical movement threshold.

In some of these embodiments, the one or more virtual reality devices comprise one or more of a virtual reality headset device or virtual reality handheld devices.

In some of these embodiments, the one or more positional coordinates are associated with a physical body of a user interacting with the one or more virtual reality devices.

In some of these embodiments, the one or more movement parameters comprise one or more of acceleration, velocity, or direction of travel and are associated with a rigid body representation of a physical body of a user interacting with the one or more virtual reality devices.

In some of these embodiments, the method further comprises generating and providing, via the first processor and to a graphics processing unit, a frame for rendering including the periphery occlusion.

In some of these embodiments, each of the first processor and the second processor comprise one or more of a processor, a processor core, or a processing thread.

In some of these embodiments, the method further comprises providing, to the graphics processing unit, a sequence of frames for rendering at a frame rate of at least 70 frames per second.

In some embodiments, an apparatus for in-flight visual field alteration in a virtual reality system, includes at least one processor and at least one memory storing instructions that, with the at least one processor, configure the apparatus to detect, via a first processor, one or more positional coordinates from one or more virtual reality devices. In some of these embodiments, the apparatus is configured to detect, via the first processor, one or more movement parameters associated with a virtual reality rendering. In some of these embodiments, the apparatus is configured to, upon determining, via a second processor and based at least in part on simulation of the one or more positional coordinates and the one or more movement parameters, that the one or more movement parameters represent a trigger condition, alter, via the first processor, a virtual reality rendering to replace the trigger condition with an altered visual field rendering.

In some of these embodiments, the trigger condition is a programmatically detected combination of positional coordinates representing a rigid body movement or set of rigid body movements that may lead to motion sickness in a user interacting with the one or more virtual reality devices.

In some of these embodiments, the one or more positional coordinates result in a rigid body representation of the user interacting with the one or more virtual reality devices horizontally and vertically alternating between tilting to the right and to the left.

In some of these embodiments, the altered visual field rendering results in a head or visual field of the rigid body representation turning left and right in a horizontal manner.

In some of these embodiments, the one or more virtual reality devices comprise one or more of a virtual reality headset device or virtual reality handheld devices.

In some of these embodiments, the one or more positional coordinates are associated with a physical body of a user interacting with the one or more virtual reality devices.

In some of these embodiments, the one or more movement parameters comprise one or more of acceleration, velocity, or direction of travel and are associated with a rigid body representation of a physical body of a user interacting with the one or more virtual reality devices.

In some of these embodiments, the apparatus is further configured to generate and provide, via the first processor and to a graphics processing unit, a frame for rendering including the altered visual field rendering.

In some of these embodiments, each of the first processor and the second processor comprise one or more of a processor, a processor core, or a processing thread.

In some of these embodiments, the apparatus is further configured to provide, to the graphics processing unit, a sequence of frames for rendering at a frame rate of at least 70 frames per second.

In some embodiments, a computer program product comprising at least one non-transitory computer readable storage medium storing instructions that, when executed by at least one processor, configure an apparatus to detect, via a first processor, one or more positional coordinates from one or more virtual reality devices. In some of these embodiments, the apparatus is configured to detect, via the first processor, one or more movement parameters associated with a virtual reality rendering. In some of these embodiments, the apparatus is configured to, upon determining, via a second processor and based at least in part on simulation of the one or more positional coordinates and the one or more movement parameters, that the one or more movement parameters represent a trigger condition, alter, via the first processor, a virtual reality rendering to replace the trigger condition with an altered visual field rendering.

In some of these embodiments, the trigger condition is a programmatically detected combination of positional coordinates representing a rigid body movement or set of rigid body movements that may lead to motion sickness in a user interacting with the one or more virtual reality devices.

In some of these embodiments, the one or more positional coordinates result in a rigid body representation of the user interacting with the one or more virtual reality devices horizontally and vertically alternating between tilting to the right and to the left.

In some of these embodiments, the altered visual field rendering results in a head or visual field of the rigid body representation turning left and right in a horizontal manner.

In some of these embodiments, the one or more virtual reality devices comprise one or more of a virtual reality headset device or virtual reality handheld devices.

In some of these embodiments, the one or more positional coordinates are associated with a physical body of a user interacting with the one or more virtual reality devices.

In some of these embodiments, the one or more movement parameters comprise one or more of acceleration, velocity, or direction of travel and are associated with a rigid body representation of a physical body of a user interacting with the one or more virtual reality devices.

In some of these embodiments, the apparatus is further configured to generate and provide, via the first processor and to a graphics processing unit, a frame for rendering including the altered visual field rendering.

In some of these embodiments, each of the first processor and the second processor comprise one or more of a processor, a processor core, or a processing thread.

In some of these embodiments, the apparatus is further configured to provide, to the graphics processing unit, a sequence of frames for rendering at a frame rate of at least 70 frames per second.

In some embodiments, a method for in-flight visual field alteration in a virtual reality system comprises detecting, via a first processor, one or more positional coordinates from one or more virtual reality devices. In some of these embodiments, the method further comprises detecting, via the first processor, one or more movement parameters associated with a virtual reality rendering. In some of these embodiments, the method further comprises, upon determining, via a second processor and based at least in part on simulation of the one or more positional coordinates and the one or more movement parameters, that the one or more movement parameters represent a trigger condition, alter, via the first processor, a virtual reality rendering to replace the trigger condition with an altered visual field rendering.

In some of these embodiments, the trigger condition is a programmatically detected combination of positional coordinates representing a rigid body movement or set of rigid body movements that may lead to motion sickness in a user interacting with the one or more virtual reality devices.

In some of these embodiments, the one or more positional coordinates result in a rigid body representation of the user interacting with the one or more virtual reality devices horizontally and vertically alternating between tilting to the right and to the left.

In some of these embodiments, the altered visual field rendering results in a head or visual field of the rigid body representation turning left and right in a horizontal manner.

In some of these embodiments, the one or more virtual reality devices comprise one or more of a virtual reality headset device or virtual reality handheld devices.

In some of these embodiments, the one or more positional coordinates are associated with a physical body of a user interacting with the one or more virtual reality devices.

In some of these embodiments, the one or more movement parameters comprise one or more of acceleration, velocity, or direction of travel and are associated with a rigid body representation of a physical body of a user interacting with the one or more virtual reality devices.

In some of these embodiments, the method further comprises generating and providing, via the first processor and to a graphics processing unit, a frame for rendering including the altered visual field rendering.

In some of these embodiments, each of the first processor and the second processor comprise one or more of a processor, a processor core, or a processing thread.

In some of these embodiments, the method further comprises providing, to the graphics processing unit, a sequence of frames for rendering at a frame rate of at least 70 frames per second.

In some embodiments, an apparatus for activating positional scale alteration in a virtual reality system comprises at least one processor and at least one memory storing instructions that, with the at least one processor, configure the apparatus to, upon determining, via a first processor, that one or more connected user devices associated with a first user interacting with a virtual reality rendering via one or more first virtual reality devices have transitioned from a first state to a second state, detect, via a first processor, one or more positional coordinates from the one or more first virtual reality devices, detect, via the first processor, one or more movement parameters associated with the virtual reality rendering, and generate, via the first processor and based on a simulation from the second processor, an altered virtual reality rendering in which a positional scale alteration is activated for the one or more first virtual reality devices.

In some of these embodiments, the apparatus is further configured to eliminate renderings associated with collisions associated with a rigid body of the first user within the altered virtual reality rendering.

In some of these embodiments, activation of the positional scale alteration results virtual reality objects within the altered virtual reality rendering being associated with reduced scale as compared to an original scale within the virtual reality rendering.

In some of these embodiments, the reduced scale is one-tenth ( 1/10th) the original scale.

In some of these embodiments, the reduced scale is a fraction of the original scale.

In some embodiments, a computer program product comprising at least one non-transitory computer readable storage medium stores instructions that, when executed by at least one processor, configure an apparatus to, upon determining, via a first processor, that one or more connected user devices associated with a first user interacting with a virtual reality rendering via one or more first virtual reality devices have transitioned from a first state to a second state, detect, via the first processor, one or more positional coordinates from the one or more first virtual reality devices, detect, via the first processor, one or more movement parameters associated with the virtual reality rendering, and generate, via the first processor and based on a simulation from the second processor, an altered virtual reality rendering in which a positional scale alteration is activated for the one or more first virtual reality devices.

In some of these embodiments, the apparatus is further configured to eliminate renderings associated with collisions associated with a rigid body of the first user within the altered virtual reality rendering.

In some of these embodiments, activation of the positional scale alteration results virtual reality objects within the altered virtual reality rendering being associated with reduced scale as compared to an original scale within the virtual reality rendering.

In some of these embodiments, the reduced scale is one-tenth ( 1/10th) the original scale.

In some of these embodiments, the reduced scale is a fraction of the original scale.

In some embodiments, a computer-implemented method, comprises, upon determining, via a first processor, that one or more connected user devices associated with a first user interacting with a virtual reality rendering via one or more first virtual reality devices have transitioned from a first state to a second state, detecting, via the first processor, one or more positional coordinates from the one or more first virtual reality devices, detecting, via the first processor, one or more movement parameters associated with the virtual reality rendering, and generating, via the first processor and based on a simulation from the second processor, an altered virtual reality rendering in which a positional scale alteration is activated for the one or more first virtual reality devices.

In some of these embodiments, the method further comprises eliminating renderings associated with collisions associated with a rigid body of the first user within the altered virtual reality rendering.

In some of these embodiments, activation of the positional scale alteration results virtual reality objects within the altered virtual reality rendering being associated with reduced scale as compared to an original scale within the virtual reality rendering.

In some of these embodiments, the reduced scale is one-tenth ( 1/10th) the original scale.

In some of these embodiments, the reduced scale is a fraction of the original scale.

In some embodiments, a multi-processor apparatus comprises a plurality of processors and at least one memory storing instructions that, with the plurality of processors, configure the multi-processor apparatus to detect, via a first processor and responsive to a virtual reality frame rendering request associated with a first frame, a plurality of rigid body objects. In some of these embodiments, the apparatus is further configured to, for each rigid body object of the plurality of rigid body objects, generate, via a second processor and in response to a simulation request from the first processor, one or more rigid body simulation objects based on simulating one or more movements of the rigid body object in relation to other rigid body objects of the plurality of rigid body objects. In some of these embodiments, the apparatus is further configured to provide, via the second processor and to the first processor, the one or more rigid body simulation objects for each rigid body of the plurality of rigid body objects. In some of these embodiments, the apparatus is further configured to apply, via the first processor, the one or more rigid body simulation objects to the rigid body objects while generating the first frame for rendering.

In some of these embodiments, the virtual reality frame rendering request is received from one or more virtual reality devices. In some of these embodiments, a particular rigid body is associated with one or more virtual reality devices and a user interacting therewith. In some of these embodiments, one or more positional coordinates obtained from the one or more virtual reality devices result in a rigid body representation of a physical body of the user. In some of these embodiments, the one or more virtual reality devices comprise one or more of a virtual reality headset device or virtual reality handheld devices. In some of these embodiments, movement parameters comprising one or more of acceleration, velocity, or direction of travel associated with a rigid body representation of a physical body of a user interacting with the one or more virtual reality devices are accounted for in the simulation.

In some of these embodiments, the apparatus is further configured to provide, via the first processor and to a graphics processing unit, the first frame for rendering.

In some of these embodiments, each of the first processor and the second processor comprise one or more of a processor, a processor core, or a processing thread.

In some of these embodiments, the apparatus is further configured to provide, to the graphics processing unit, a sequence of frames for rendering at a frame rate of at least 70 frames per second.

In some of these embodiments, the simulation is based in part on gravity and collisions. In some of these embodiments, the simulation request comprises a request to perform a simulation and return results of the simulation in real time. In some of these embodiments, the simulation request comprises a raycast or query request.

In some embodiments, a computer program product comprises at least one non-transitory computer readable storage medium storing instructions that, when executed by at least one processor, configure an apparatus to detect, via a first processor and responsive to a virtual reality frame rendering request associated with a first frame, a plurality of rigid body objects. In some of these embodiments, the apparatus is further configured to, for each rigid body object of the plurality of rigid body objects, generate, via a second processor and in response to a simulation request from the first processor, one or more rigid body simulation objects based on simulating one or more movements of the rigid body object in relation to other rigid body objects of the plurality of rigid body objects. In some of these embodiments, the apparatus is further configured to provide, via the second processor and to the first processor, the one or more rigid body simulation objects for each rigid body of the plurality of rigid body objects. In some of these embodiments, the apparatus is further configured to apply, via the first processor, the one or more rigid body simulation objects to the rigid body objects while generating the first frame for rendering.

In some of these embodiments, the virtual reality frame rendering request is received from one or more virtual reality devices. In some of these embodiments, a particular rigid body is associated with one or more virtual reality devices and a user interacting therewith. In some of these embodiments, one or more positional coordinates obtained from the one or more virtual reality devices result in a rigid body representation of a physical body of the user. In some of these embodiments, the one or more virtual reality devices comprise one or more of a virtual reality headset device or virtual reality handheld devices. In some of these embodiments, movement parameters comprising one or more of acceleration, velocity, or direction of travel associated with a rigid body representation of a physical body of a user interacting with the one or more virtual reality devices are accounted for in the simulation.

In some of these embodiments, the apparatus is further configured to provide, via the first processor and to a graphics processing unit, the first frame for rendering.

In some of these embodiments, each of the first processor and the second processor comprise one or more of a processor, a processor core, or a processing thread.

In some of these embodiments, the apparatus is further configured to provide, to the graphics processing unit, a sequence of frames for rendering at a frame rate of at least 70 frames per second.

In some of these embodiments, the simulation is based in part on gravity and collisions. In some of these embodiments, the simulation request comprises a request to perform a simulation and return results of the simulation in real time. In some of these embodiments, the simulation request comprises a raycast or query request.

In some embodiments, a computer-implemented method comprises detecting, via a first processor and responsive to a virtual reality frame rendering request associated with a first frame, a plurality of rigid body objects. In some of these embodiments, the method further comprises, for each rigid body object of the plurality of rigid body objects, generating, via a second processor and in response to a simulation request from the first processor, one or more rigid body simulation objects based on simulating one or more movements of the rigid body object in relation to other rigid body objects of the plurality of rigid body objects. In some of these embodiments, the method further comprises providing, via the second processor and to the first processor, the one or more rigid body simulation objects for each rigid body of the plurality of rigid body objects. In some of these embodiments, the method further comprises applying, via the first processor, the one or more rigid body simulation objects to the rigid body objects while generating the first frame for rendering.

In some of these embodiments, the virtual reality frame rendering request is received from one or more virtual reality devices. In some of these embodiments, a particular rigid body is associated with one or more virtual reality devices and a user interacting therewith. In some of these embodiments, one or more positional coordinates obtained from the one or more virtual reality devices result in a rigid body representation of a physical body of the user. In some of these embodiments, the one or more virtual reality devices comprise one or more of a virtual reality headset device or virtual reality handheld devices. In some of these embodiments, movement parameters comprising one or more of acceleration, velocity, or direction of travel associated with a rigid body representation of a physical body of a user interacting with the one or more virtual reality devices are accounted for in the simulation.

In some of these embodiments, the method further comprises providing, via the first processor and to a graphics processing unit, the first frame for rendering.

In some of these embodiments, each of the first processor and the second processor comprise one or more of a processor, a processor core, or a processing thread.

In some of these embodiments, the method further comprises providing, to the graphics processing unit, a sequence of frames for rendering at a frame rate of at least 70 frames per second.

In some of these embodiments, the simulation is based in part on gravity and collisions. In some of these embodiments, the simulation request comprises a request to perform a simulation and return results of the simulation in real time. In some of these embodiments, the simulation request comprises a raycast or query request.

In some embodiments, a multi-processor apparatus comprises a plurality of processors and at least one memory storing instructions that, with the plurality of processors, configure the multi-processor apparatus to detect, via a first processor and at a beginning of a first frame, a plurality of positional objects. In some of these embodiments, the apparatus is further configured to, for each positional object of the plurality of positional objects, determine, via a second processor and in response to an evaluation request from the first processor, a positional object distance associated with the positional object relative to a viewer position, assign, via the second processor, a detail level to the positional object based on its associated positional object distance, and provide, via the second processor, the detail level for the positional object to the first processor. In some of these embodiments, the apparatus is further configured to, based at least in part on the detail levels for each positional object of the plurality of positional objects for the first frame, and via the first processor, generate each positional object to be rendered within the first frame. In some of these embodiments, the apparatus is further configured to provide, via the first processor and to a graphics processing unit, the first frame for rendering via the graphics processing unit.

In some of these embodiments, the positional object is one of a dynamic object or a static object. In some of these embodiments, the apparatus is further configured to, for each frame, update a detail level for a plurality of dynamic objects. In some of these embodiments, assigning the detail level to the positional object comprises retrieving a previous associated positional object distance associated with the positional object, and, upon determining that a current positional object distance is equivalent or within a distance threshold of the previous associated positional object distance, assigning a previous detail level to the positional object instead of calculating a new detail level for the positional object.

In some of these embodiments, determining the positional object distance associated with the positional object relative to the viewer position comprises performing a line cast analysis.

In some of these embodiments, each of the first processor and the second processor comprise one or more of a processor, a processor core, or a processing thread.

In some of these embodiments, the apparatus is further configured to provide, to the graphics processing unit, a sequence of frames for rendering at a frame rate of at least 70 frames per second.

In some embodiments, a computer program product comprises at least one non-transitory computer readable storage medium storing instructions that, when executed by at least one processor, configure an apparatus to detect, via a first processor and at a beginning of a first frame, a plurality of positional objects. In some of these embodiments, the apparatus is further configured to, for each positional object of the plurality of positional objects, determine, via a second processor and in response to an evaluation request from the first processor, a positional object distance associated with the positional object relative to a viewer position, assign, via the second processor, a detail level to the positional object based on its associated positional object distance, and provide, via the second processor, the detail level for the positional object to the first processor. In some of these embodiments, the apparatus is further configured to, based at least in part on the detail levels for each positional object of the plurality of positional objects for the first frame, and via the first processor, generate each positional object to be rendered within the first frame. In some of these embodiments, the apparatus is further configured to provide, via the first processor and to a graphics processing unit, the first frame for rendering via the graphics processing unit.

In some of these embodiments, the positional object is one of a dynamic object or a static object. In some of these embodiments, the apparatus is further configured to, for each frame, update a detail level for a plurality of dynamic objects. In some of these embodiments, assigning the detail level to the positional object comprises retrieving a previous associated positional object distance associated with the positional object, and, upon determining that a current positional object distance is equivalent or within a distance threshold of the previous associated positional object distance, assigning a previous detail level to the positional object instead of calculating a new detail level for the positional object.

In some of these embodiments, determining the positional object distance associated with the positional object relative to the viewer position comprises performing a line cast analysis.

In some of these embodiments, each of the first processor and the second processor comprise one or more of a processor, a processor core, or a processing thread.

In some of these embodiments, the apparatus is further configured to provide, to the graphics processing unit, a sequence of frames for rendering at a frame rate of at least 70 frames per second.

In some embodiments, a computer-implemented method comprises detecting, via a first processor and at a beginning of a first frame, a plurality of positional objects. In some embodiments, the method further comprises, for each positional object of the plurality of positional objects, determining, via a second processor and in response to an evaluation request from the first processor, a positional object distance associated with the positional object relative to a viewer position, assigning, via the second processor, a detail level to the positional object based on its associated positional object distance, and providing, via the second processor, the detail level for the positional object to the first processor. In some of these embodiments, the method further comprises, based at least in part on the detail levels for each positional object of the plurality of positional objects for the first frame, and via the first processor, generating each positional object to be rendered within the first frame. In some of these embodiments, the method further comprises providing, via the first processor and to a graphics processing unit, the first frame for rendering via the graphics processing unit.

In some of these embodiments, the positional object is one of a dynamic object or a static object. In some of these embodiments, the method further comprises, for each frame, updating a detail level for a plurality of dynamic objects. In some of these embodiments, assigning the detail level to the positional object comprises retrieving a previous associated positional object distance associated with the positional object, and, upon determining that a current positional object distance is equivalent or within a distance threshold of the previous associated positional object distance, assigning a previous detail level to the positional object instead of calculating a new detail level for the positional object.

In some of these embodiments, determining the positional object distance associated with the positional object relative to the viewer position comprises performing a line cast analysis.

In some of these embodiments, each of the first processor and the second processor comprise one or more of a processor, a processor core, or a processing thread.

In some of these embodiments, the method further comprises providing, to the graphics processing unit, a sequence of frames for rendering at a frame rate of at least 70 frames per second.

In some embodiments, a system for monitoring performance of a virtual reality system comprises a plurality of virtual reality devices, and one or more benchmark server devices in communication with the plurality of virtual reality devices. In some of these embodiments, the one or more benchmark server devices are configured to record performance metrics associated with each virtual reality device of the plurality of virtual reality devices while every virtual reality headset device of the plurality of virtual reality headset devices simultaneously interacts with a particular virtual reality application session.

In some of these embodiments, the system further comprises a central server device in communication with the one or more benchmark server devices. In some of these embodiments, the central server device is configured to cause rendering of a virtual reality performance interface comprising one or more performance interface elements associated with the recorded performance metrics and the particular virtual reality application session.

In some of these embodiments, performance metrics comprise one or more of virtual reality device component temperature or frame rate.

In some of these embodiments, each virtual reality device of the plurality of virtual reality devices is associated with a unique user identifier.

In some of these embodiments, a virtual reality device interacts with the particular virtual reality application session by providing physical positional coordinates associated with a user interacting with the virtual reality device so that a rigid body associated with the user can be simulated and rendered within the particular virtual reality application session.

In some of these embodiments, a virtual reality device comprises one or more of a virtual reality headset device or a virtual reality handheld device.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

To the extent the embodiments disclosed herein include or operate in association with memory, storage, and/or computer readable media, then that memory, storage, and/or computer readable media are non-transitory. Accordingly, to the extent that memory, storage, and/or computer readable media are covered by one or more claims, then that memory, storage, and/or computer readable media is only non-transitory.

As used herein and in the appended claims, the singular forms “a,” “an,” and “the” include plural referents unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

1. An apparatus for dynamic periphery occlusion in a virtual reality system, the apparatus comprising at least one processor and at least one memory storing instructions that, with the at least one processor, configure the apparatus to:
detect, via a first processor, one or more positional coordinates from one or more virtual reality devices;
detect, via the first processor, one or more movement parameters associated with a virtual reality rendering; and
upon determining, via a second processor and based at least in part on simulation of the one or more positional coordinates and the one or more movement parameters, that one or more movement parameters of the one or more movement parameters exceeds a first physical movement threshold, adjust, via the first processor, periphery occlusion associated with the virtual reality rendering.

2. The apparatus of claim 1, wherein the first physical movement threshold is selected from a plurality of physical movement thresholds.

3. The apparatus of claim 1, wherein the first physical movement threshold is selected based at least in part on a virtual movement state.

4. The apparatus of claim 3, wherein the virtual movement state is determined via the second processor and based at least in part on the simulation of the one or more positional coordinates and the one or more movement parameters.

5. The apparatus of claim 4, wherein the virtual movement state comprises a negative acceleration parameter exceeding a negative acceleration threshold.

6. The apparatus of claim 2, wherein each physical movement threshold of the plurality of physical movement thresholds is adjustable for a given user via the one or more virtual reality devices.

7. The apparatus of claim 2, wherein each physical movement threshold of the plurality of physical movement thresholds is dynamically updated over time based on historical movement parameters associated with a given user.

8. The apparatus of claim 1, wherein adjusting periphery occlusion associated with the virtual reality rendering comprises altering an area of pixels located along a periphery of each eye-specific frame of a frame of the virtual reality rendering.

9. The apparatus of claim 8, wherein altering the area of pixels comprises one or more of blurring each pixel of the area of pixels or applying a uniform color to each pixel of the area of pixels.

10. The apparatus of claim 8, wherein adjusting periphery occlusion further comprises adjusting a size of the area of pixels based in part on the first physical movement threshold.

11. The apparatus of claim 1, wherein the one or more virtual reality devices comprise one or more of a virtual reality headset device or virtual reality handheld devices.

12. The apparatus of claim 1, wherein the one or more positional coordinates are associated with a physical body of a user interacting with the one or more virtual reality devices.

13. The apparatus of claim 1, wherein the one or more movement parameters comprise one or more of acceleration, velocity, or direction of travel and are associated with a rigid body representation of a physical body of a user interacting with the one or more virtual reality devices.

14. The apparatus of claim 1, further configured to generate and provide, via the first processor and to a graphics processing unit, a frame for rendering including the periphery occlusion.

15. The apparatus of claim 1, wherein each of the first processor and the second processor comprise one or more of a processor, a processor core, or a processing thread.

16. The apparatus of claim 14, wherein the apparatus is further configured to provide, to the graphics processing unit, a sequence of frames for rendering at a frame rate of at least 70 frames per second.

17. A computer program product comprising at least one non-transitory computer readable storage medium storing instructions that, when executed by at least one processor, configure an apparatus to:
detect, via a first processor, one or more positional coordinates from one or more virtual reality devices;
detect, via the first processor, one or more movement parameters associated with a virtual reality rendering; and
upon determining, via a second processor and based at least in part on simulation of the one or more positional coordinates and the one or more movement parameters, that one or more movement parameters of the one or more movement parameters exceeds a first physical movement threshold, adjust, via the first processor, periphery occlusion associated with the virtual reality rendering.

18-29. (canceled)

30. The computer program product of claim 17, wherein the apparatus is further configured to generate and provide, via the first processor and to a graphics processing unit, a frame for rendering including the periphery occlusion.

31. (canceled)

32. The computer program product of claim 30, wherein the apparatus is further configured to provide, to the graphics processing unit, a sequence of frames for rendering at a frame rate of at least 70 frames per second.

33. A computer implemented method, comprising:
detecting, via a first processor, one or more positional coordinates from one or more virtual reality devices;
detecting, via the first processor, one or more movement parameters associated with a virtual reality rendering; and
upon determining, via a second processor and based at least in part on simulation of the one or more positional coordinates and the one or more movement parameters, that one or more movement parameters of the one or more movement parameters exceeds a first physical movement threshold, adjusting, via the first processor, periphery occlusion associated with the virtual reality rendering.

34-156. (canceled)
